(19) United States
(12) Patent Application Publication
(10) Pub. No.: US 2016/0065974 A1
(43) Pub. Date: Mar. 3, 2016

(54) METHOD AND APPARATUS FOR ENCODING AND DECODING VIDEO WITH RESPECT TO FILTERING

(71) Applicant: SAMSUNG ELECTRONICS CO., LTD., Suwon-si (KR)

(72) Inventors: Elena ALSHINA, Suwon-si (KR); Alexander ALSHIN, Suwon-si (KR); Yong-jin CHO, Seoul (KR)

(73) Assignee: SAMSUNG ELECTRONICS CO., LTD., Suwon-si (KR)

(21) Appl. No.: 14/782,441

(22) PCT Filed: Apr. 7, 2014
(86) PCT No.: PCT/KR14/03007

§ 371 Date: Oct. 5, 2015

Related U.S. Application Data
(60) Provisional application No. 61/835,813, filed on Jun. 17, 2013.
(60) Provisional application No. 61/809,011, filed on Apr. 5, 2013.

(51) Int. Cl. H04N 19/186; H04N 19/44

(52) U.S. Cl. CPC H04N 19/186; H04N 19/44

(57) ABSTRACT

A video decoding method includes receiving information about whether to correct a chroma sample, obtaining a correction value determined using a luma value in a range corresponding to a position of a determined chroma pixel, based on the received information, and correcting a chroma value using the obtained correction value.

### TECHNICAL FIELD

The present invention relates to a method and apparatus for encoding and decoding video with respect to filtering.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macro block having a predetermined size.

A video codec reduces a data amount using a prediction technique using a feature that video images have high correlativity in terms of time or space. According to the prediction technique, in order to predict a current image using a surrounding image, image information is recorded using a temporal distance or a spatial distance between images, a prediction error, etc.

### DETAILED DESCRIPTION OF THE INVENTION

### Technical Problem

The present invention provides a method of correcting a chromatic value related to filtering.

### Technical Solution

According to an aspect of the present invention, efficient encoding and decoding are available by correcting a chroma value using a luma value.

### Advantageous Effects

In a YCbCr 4:2:0 format, a chroma sample of Cb and Cr to Y may be sampled at a ratio of 1:4. Accordingly, efficient encoding and decoding are available by correcting a chroma value using a luma value.

### DESCRIPTION OF THE DRAWINGS

FIG. 1A is a block diagram of a structure of a video encoding apparatus according to one or more embodiments.

FIG. 1B is a flowchart of a method of correcting a chroma value by determining a correction value and transmitting information about whether to correct a chroma value, according to one or more embodiments.

FIG. 2A is a block diagram of a structure of a video decoding apparatus according to one or more embodiments.

FIG. 2B is a flowchart of a method of receiving information about whether a chroma sample is corrected, obtaining a correction value, and correcting a chroma value, according to one or more embodiments.

FIG. 3A is a flowchart of a method of receiving information about whether a chroma sample is corrected and then receiving information about whether a blue chroma signal Cb and a red chroma signal Cr of chroma values are corrected, according to one or more embodiments.

FIG. 3B is a flowchart of a method of correcting a chroma value to be upsampled, according to one or more embodiments.

FIG. 3C is a flowchart of a method of performing upsampling using a chroma value to be corrected, according to one or more embodiments.

FIG. 3D is a flowchart of a method of receiving and using information about a vertex of a range of a chroma pixel to be corrected, according to one or more embodiments.

FIG. 4A illustrates a method of correcting a chroma value according to one or more embodiments.

FIG. 4B illustrates a method of correcting a chroma value according to one or more embodiments.

FIG. 4C illustrates a method of correcting a chroma value according to one or more embodiments.

FIG. 5A is a block diagram of a method of correcting a chroma value using a luma value before upsampling is performed, according to one or more embodiments.

FIG. 5B is a block diagram of a method of correcting a chroma value using a luma value after upsampling is performed, according to one or more embodiments.

FIG. 6A illustrates a method of receiving and parsing information about whether to perform filtering, according to one or more embodiments.

FIG. 6B illustrates a method of calling a slice segment header extension function by a slice segment header, according to one or more embodiments.

FIG. 6C illustrates a method of receiving and parsing information about whether to perform filtering according to a chroma type of a chroma, according to one or more embodiments.

FIG. 6D illustrates a method of receiving and parsing information about whether to perform filtering according to a chroma type of a chroma, according to one or more embodiments.

FIG. 7 illustrates a method of performing matching between a current layer and a reference layer, according to one or more embodiments.

FIG. 8 is a block diagram of a video encoding apparatus based on coding units according to a tree structure, according to one or more embodiments.

FIG. 9 is a block diagram of a video decoding apparatus based on coding units according to a tree structure, according to one or more embodiments.

FIG. 10 is a diagram for describing a concept of coding units according to one or more embodiments.

FIG. 11 is a block diagram of an image encoder based on coding units, according to one or more embodiments.

FIG. 12 is a block diagram of an image decoder based on coding units, according to one or more embodiments.

FIG. 13 is a diagram illustrating deeper coding units according to depths, and partitions, according to one or more embodiments.

FIG. 14 is a diagram for describing a relationship between a coding unit and transformation units, according to one or more embodiments.

FIG. 15 is a diagram for describing encoding information of coding units corresponding to a depth, according to one or more embodiments.

FIG. 16 is a diagram of deeper coding units according to depths, according to one or more embodiments.

FIGS. 17, 18, and 19 are diagrams for describing a relationship between coding units, prediction units, and transformation units, according to one or more embodiments.

FIG. 20 is a diagram for describing a relationship between a coding unit, a prediction unit, and a transformation unit, according to encoding mode information of Table 1.

FIG. 21 is a diagram of a physical structure of a disc in which a program is stored, according to one or more embodiments.

FIG. 22 is a diagram of a disc drive for recording and reading a program by using a disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method are applied, according to one or more embodiments.

FIG. 26 is a diagram of a digital broadcast system to which a communication system is applied, according to one or more embodiments.

FIG. 27 is a diagram illustrating a network structure of a cloud computing system using a video encoding apparatus and a video decoding apparatus, according to one or more embodiments.

### BEST MODE

A video encoding method may include receiving information about whether to correct a chroma sample, obtaining a correction value determined using a luma value in a range corresponding to a position of a determined chroma pixel, based on the received information, and correcting a chroma value using the obtained correction value.

### Mode of the Inventive Concept

In the below-described embodiments, the term “image” may comprehensively denote not only a still image, but also a moving picture such as a video.

As used herein, the term “sample” signifies data subject to processing as data assigned to a sampling position of an image. For example, in an image of a space area, pixels may be samples.

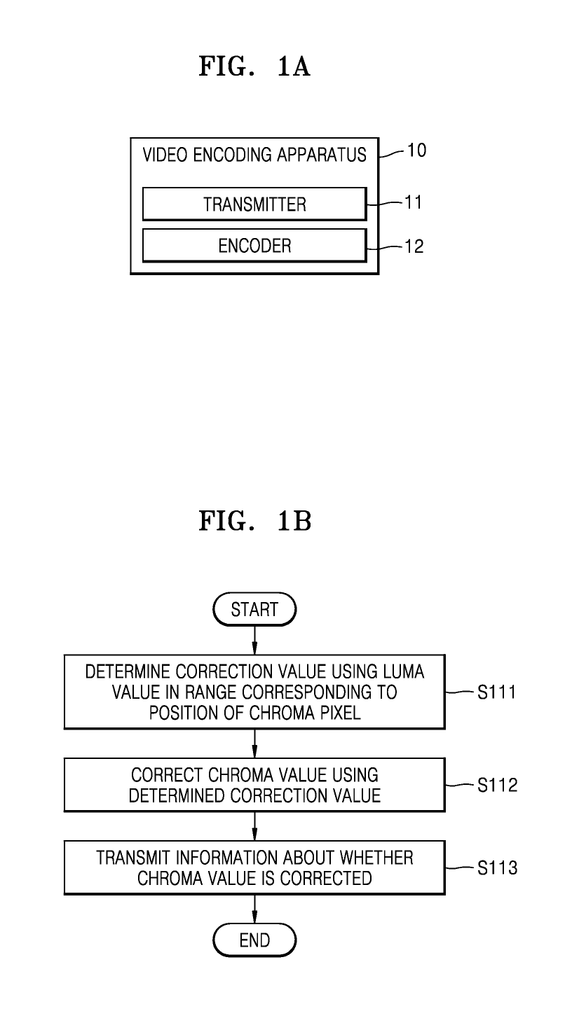

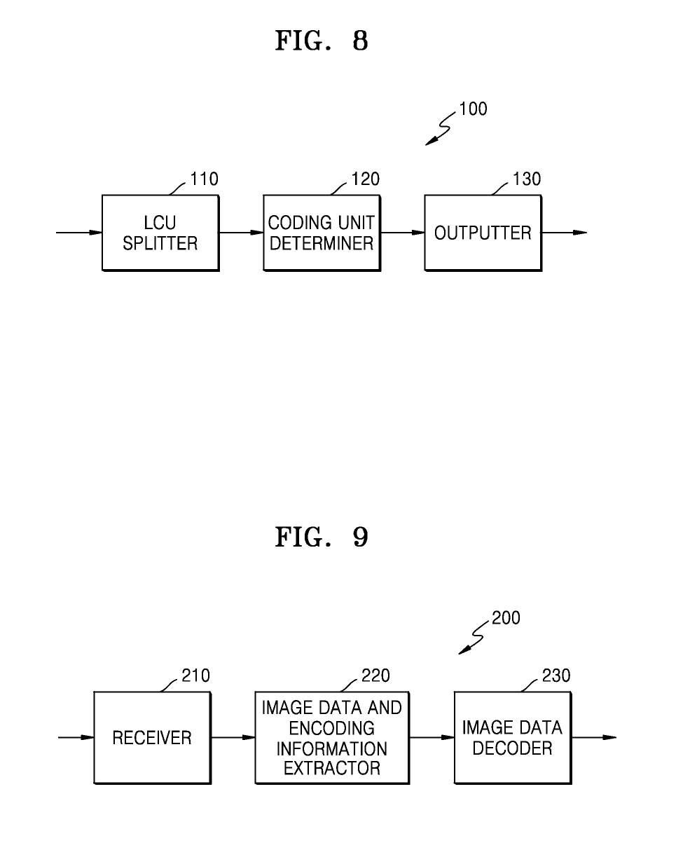

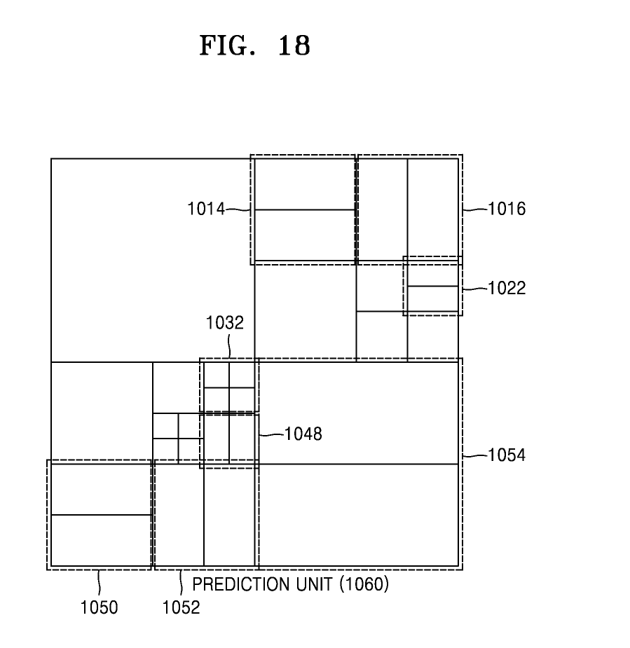

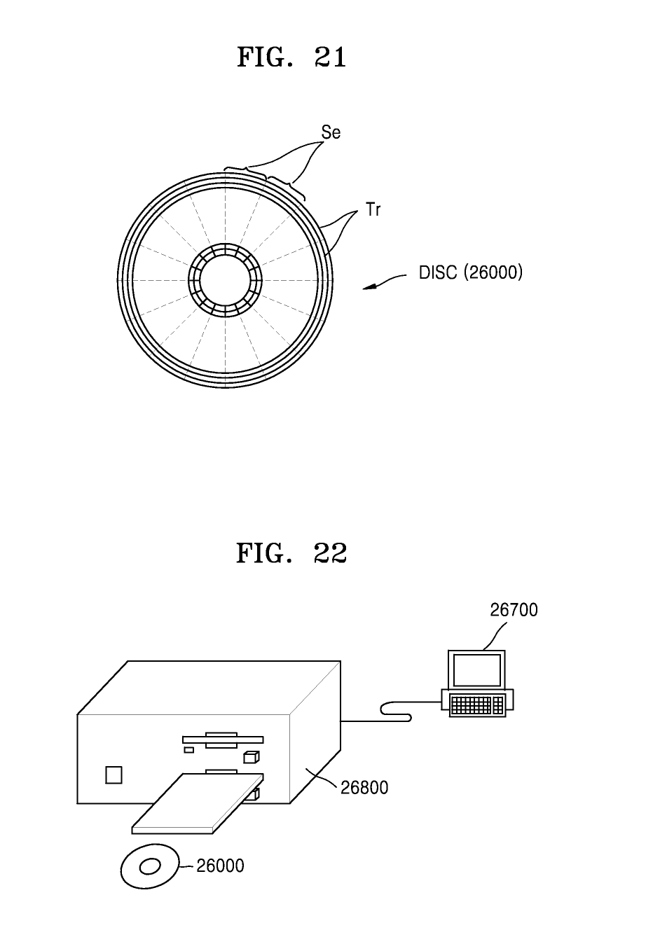

Hereinafter, a method and apparatus for encoding and decoding a video with respect to a position of an integer pixel according to one or more embodiments is described with reference to FIGS. 1A to 7. Also, a video encoding technique and a video decoding technique based on coding units according to a tree structure, according to one or more embodiments, which are applicable to the above presented video encoding and decoding techniques are described with reference to FIGS. 8 to 20. Also, one or more embodiments, to which the above presented video encoding and decoding methods are applicable, are described with reference to FIGS. 21 to 27.

To display a color image, a YCbCr color space is present in the form of separately storing a luma sample and a chroma sample for each pixel. Y may denote a luma sample and Cb and Cr may denote a chroma sample. A YCbCr sampling format may be 4:4:4, 4:2:2, or 4:2:0. In a YCbCr 4:2:0 format, a chroma sample of Cb and Cr with respect to Y may be sampled at a ratio of 1:4.

Also, there may be a correlation between a chroma value and a luma value. Accordingly, correction on a chroma value may be performed using the correlation existing between a chroma value and a luma value.

Also, the correlation between a chroma value and a luma value may be related to a distance between a chroma pixel and a luma pixel. Alternatively, only a luma value located within a predetermined range from a chroma pixel may be related to a chroma value.

For example, only a luma value located within a predetermined distance from a first chroma pixel may be related to a chroma value of the first chroma pixel.

In another example, the amount of relevancy between a chroma value and a luma value may be inversely proportional to the distance between a chroma pixel and a luma pixel.

A video encoding apparatus 10 may determine a correction value to correct a chroma value using a luma value in a range corresponding to a position of a chroma pixel to be encoded.

The range corresponding to a position of a chroma pixel to be encoded may be determined in advance.

Alternatively, the range corresponding to a position of a chroma pixel to be encoded may be changed according to a situation.

Methods of performing encoding and decoding using the relevancy between a chroma value and a luma value according to one or more embodiments are described below.

FIG. 1A is a block diagram of a structure of the video encoding apparatus 10 according to one or more embodiments.

Referring to FIG. 1A, the video encoding apparatus 10 may include a transmitter 11 and an encoder 12. However, the video encoding apparatus 10 may be embodied by elements more or less than the number of the illustrated elements.

The video encoding apparatus 10 according to one or more embodiments may encode a plurality of image sequences classified by layers according to a scalable video coding method, and output separate streams including data encoded by layers. The video encoding apparatus 10 may encode a current layer image sequence and a reference layer image sequence to be different layers.

The encoder 12 may encode current layer images and output a current layer stream including coded data of the current layer images.

The encoder 12 may encode reference layer images and output a reference layer stream including coded data of the reference layer images.

For example, according to a scalable video coding method based on spatial scalability, low resolution images are encoded as reference layer images, and high resolution images may be encoded as current layer images. A coding result of reference layer images may be output as a reference layer stream, and a coding result of current layer images may be output as a current layer stream.

In another example, a multi-view video may be encoded according to the scalable video coding method. Left-view images may be encoded as reference layer images, and right-view images may be encoded as current layer images. Alternatively, center-view images, left-view images, and right-view images are respectively encoded. Among the above images, the center-view images may be encoded as current layer images, the left-view images may be encoded as reference layer images, and the right-view images may be encoded as other reference layer images.

In another example, the scalable video coding method may be performed according to temporal hierarchical prediction based on temporal scalability. A reference layer stream including coding information generated by encoding images of a basic frame rate may be output. Temporal levels are classified by frame rates and each temporal level may be encoded to each layer. Images of a high speed rate are further encoded by referring to the images of a basic frame rate and thus a current layer stream including coding information of a high speed frame rate may be output.

Also, a scalable video coding may be performed on a reference layer and a plurality of current layers. When there are three or more current layers, reference layer images and first current layer images, second current layer images, . . . , and K-th current layer images may be encoded. Accordingly, a coding result of the reference layer images may be output as a reference layer stream, and a coding result of the first, second, . . . , and K-th current layer images may be respectively output as first, second, . . . , and K-th current layer streams.

The video encoding apparatus 10 according to one or more embodiments may perform inter-prediction for predicting a current image by referring to images of a single layer. A motion vector indicating movement information between a current image and a reference image and a residual between a current image and a reference image may be generated.

Also, the video encoding apparatus 10 may perform inter-layer prediction for predicting current layer images by referring to the reference layer images.

Also, when the video encoding apparatus 10 according to an embodiment allows three or more layers such as a reference layer, a current layer, and a reference layer, inter-layer prediction between a reference layer image and a reference layer image or inter-layer prediction between a current layer image and a reference layer image may be performed according to a multilayer prediction structure.

A position difference component between a current image and a reference image of another layer, and a residual between a current image and a reference image of another layer, may be generated by the inter-layer prediction.

The video encoding apparatus 10 according to one or more embodiments encodes each image of a video by blocks, for each layer. A type of a block may be a square, a rectangle, or any geometrical shape, but not limited to a data unit of a certain size. The block may be a maximum coding unit, a coding unit, a prediction unit, or a transformation unit among coding units according to a tree structure. A maximum coding unit including coding units of a tree structure may be variously named as a coding tree unit, a coding block tree, a block tree, a root block tree, a coding tree, a coding root, or a tree trunk. A video encoding/decoding method based on coding units according to a tree structure is described below with reference to FIGS. 8 to 20.

The inter-prediction and inter-layer prediction may be performed based on a data unit of a coding unit, a prediction unit, or a transformation unit.

The encoder 12 according to one or more embodiments may generate symbol data by performing source coding operations including inter-prediction or intra-prediction with respect to the reference layer images. A symbol data indicates a sample value of each coding parameter and a sample value of a residual.

For example, the encoder 12 may generate system data by performing inter-/intra-prediction, transformation, and quantization on samples of data units of the reference layer images, and generate a reference layer stream by performing entropy encoding on the symbol data.

The encoder 12 may encode current layer images based on the coding units of a tree structure. The encoder 12 may generate symbol data by performing inter-/intra-prediction, transformation, and quantization on samples of coding units of the current layer images, and generate a current layer stream by performing entropy encoding on the symbol data.

The encoder 12 according to one or more embodiments may perform inter-layer prediction for predicting a current layer image by using a reconstructed sample of the reference layer image. The encoder 12 may generate a current layer prediction image by using a reference layer reconstructed image to encode a current layer original image of the current layer image sequence through an inter-layer prediction structure, and encode a prediction error between the current layer original image and the current layer prediction image.

The encoder 12 may perform an inter-layer prediction on the current layer image by blocks such as coding units or prediction units. The encoder 12 may determine a block of the reference layer image that is to be referred to by a block of the current layer image. For example, a reconstructed block of the reference layer image located corresponding to a position of a current block in the current layer image may be determined. The encoder 12 may determine a current layer prediction block by using a reference layer reconstructed block corresponding to a current layer block.

The encoder 12 may use the current layer prediction block determined by using the reference layer reconstructed block, as a reference image for inter-layer prediction of a current layer original block, according to the inter-layer prediction structure. The encoder 12 may perform entropy encoding by transforming and quantizing an error between a sample value of the current layer prediction block and a sample value of the current layer original block, that is, a residual according to the inter-layer prediction, by using the reference layer reconstructed image.

As described above, the encoder 12 may encode a current layer image sequence referring to reference layer reconstructed images through the inter-layer prediction structure. However, the encoder 12 according to one or more embodiments may encode the current layer image sequence according to a single layer prediction structure, without referring to other layer samples. Accordingly, the encoder 12 is not limited to perform only the inter-layer prediction to encode the current layer image sequence.

Alternatively, in order to induce a luminance compensation parameter according to an embodiment, a surrounding pixel value of a reference layer constructed block corresponding to a current layer current block is acquired. A disparity vector may be used to find the reference layer constructed block corresponding to the current layer current block. The disparity vector may be transmitted by being included in a bitstream or induced from other coding information.

However, since a disparity vector may have a level of precision in a fractional unit such as quarter-pel or half-pel, a position indicated by the disparity vector at the position of the current layer current block may be a sub-pixel position. However, a second layer current block and a first layer reference block are compared in units of integer pixels, the position of a reference block may be determined to be the position of an integer pixel. Thus, the position of a sub-pixel indicated by the disparity vector may not be used as it is.

In order to output a result of the video encoding, the video encoding apparatus 10 may perform a video encoding operation including transformation, by interactively operating with a built-in internal video encoding processor or an external video encoding processor. The internal video encoding processor of the video encoding apparatus 10, as a separate processor, may implement the video encoding operation.

The transmitter 11 may transmit information about whether to correct a chroma value.

The encoder 12 may determine a correction value using a luma value in a range corresponding to a position of a chroma pixel, and correct a chroma value using a determined correction value.

A detailed operation of the video encoding apparatus 10 is described below with reference to FIG. 1B.

FIG. 1B is a flowchart of a method of correcting a chroma value by determining a correction value and transmitting information about whether to correct a chroma value, according to one or more embodiments.

In S111, the video encoding apparatus 10 may determine a correction value using a luma value in a range corresponding to a position of a chroma pixel.

The video encoding apparatus 10 may transmit a determined correction value.

Alternatively, the video encoding apparatus 10 may transmit only a parameter value needed for determining a correction value, without transmitting the determined correction value.

Whether the video encoding apparatus 10 transmits the determined correction value may be determined in advance. Alternatively, whether the video encoding apparatus 10 transmits the determined correction value may be changed according to a setting.

In S112, the video encoding apparatus 10 may correct a chroma value using the correction value determined in S111.

The video encoding apparatus 10 may correct the chroma value using the correction value determined in S111 and an existing chroma value through a predetermined method.

Alternatively, the video encoding apparatus 10 may correct the chroma value using the correction value determined in S111 and an existing chroma value through a method determined according to a situation.

A detailed correction method is described below.

In S113, the video encoding apparatus 10 may transmit information about whether the chroma value is corrected.

The video encoding apparatus 10 may perform correction of the chroma value or not.

The video encoding apparatus 10 may transmit, in the form of a flag, information about whether a chroma sample is corrected.

For example, the video encoding apparatus 10 may transmit a value “1” when the chroma value is corrected an a value “0” when the chroma value is not corrected.

Also, the information about whether the video encoding apparatus 10 performs correction of a chroma value may be included in a sequence parameter set (SPS), a video parameter set (VPS), a picture parameter set (PPS), a slice segment header, or a slice header.

Also, the correction of a chroma value may be independently performed according to chrominance. For example, correction of a Cb sample and correction of a Cr sample may be performed independently of each other. Accordingly, the video encoding apparatus 10 may transmit each of information about whether a Cb sample is corrected and information about whether a Cr sample is corrected.

The video encoding apparatus 10 may transmit information about whether the Cb sample is corrected, in the form of a flag.

For example the video encoding apparatus 10 may transmit a value “1” when the Cb sample is corrected and a value “0” when the Cb sample is not corrected.

Also, the information about whether the video encoding apparatus 10 performs correction of a Cb sample may be included in the SPS, the VPS, the SPS, the PPS, the slice segment header, or the slice header.

The video encoding apparatus 10 may transmit information about whether the Cr sample is corrected, in the form of a flag.

For example the video encoding apparatus 10 may transmit a value “1” when the Cr sample is corrected and a value “0” when the Cr sample is not corrected.

Also, the information about whether the video encoding apparatus 10 performs correction of a Cr sample may be included in the SPS, the VPS, the SPS, the PPS, the slice segment header, or the slice header.

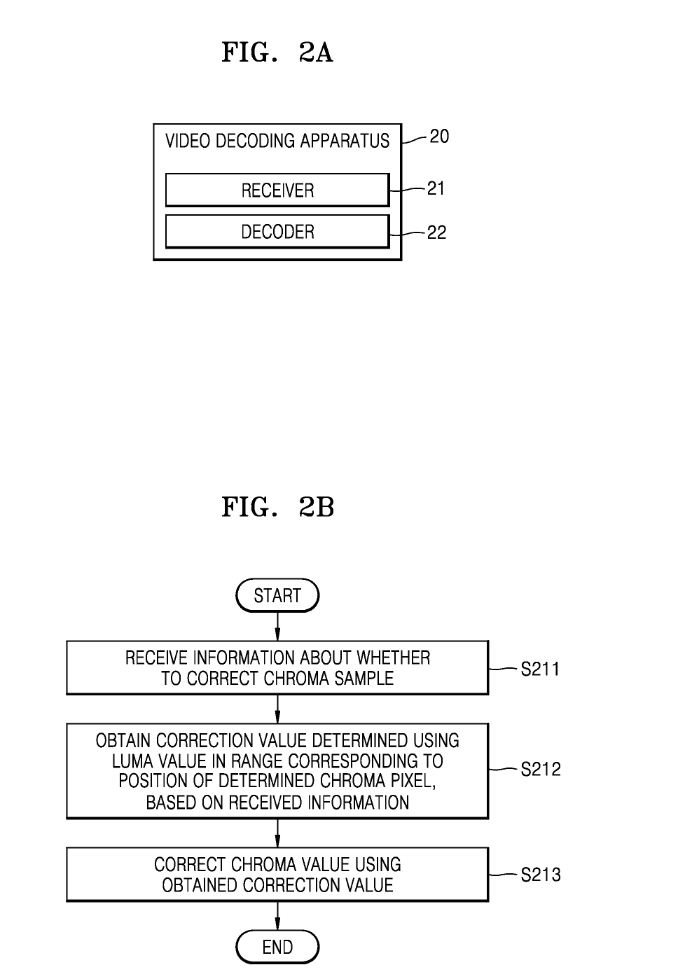

FIG. 2A is a block diagram of a structure of a video decoding apparatus 20 according to one or more embodiments.

As illustrated in FIG. 2A, the video decoding apparatus 20 may include a receiver 210 and a decoder 22. However, the video encoding apparatus 20 may be embodied by elements more or less than the number of the illustrated elements.

The video decoding apparatus 20 according to one or more embodiments may receive bitstreams by layers according to a scalable coding method. The number of layers of the bitstreams received by the video decoding apparatus 20 is not limited.

The video decoding apparatus 20 based on a spatial scalability may receive streams in which image sequences of different resolutions are encoded to different layers. A low-resolution image sequence may be reconstructed by decoding a reference layer stream, and a high-resolution image sequence may be reconstructed by decoding a current layer stream.

A multi-view video may be decoded according to the scalable video coding method. When a stereoscopic video stream is received in multiple layers, left-view images may be reconstructed by decoding the reference layer stream. Right-view images may be reconstructed by further decoding the current layer stream in addition to the reference layer stream.

Also, when a multi-view video stream is received in multiple layers, center-view images may be reconstructed by decoding the reference layer stream. Left-view images may be reconstructed by further decoding the current layer stream in addition to the reference layer stream. Right-view images may be reconstructed by further decoding the reference layer stream in addition to the reference layer stream.

The scalable video coding method based on temporal scalability may be performed. Images of a basic frame rate may be reconstructed by decoding the reference layer stream. Images of a high frame rate may be reconstructed by further decoding the current layer stream in addition to the reference layer stream.

Also, when three current layers exist, the reference layer images are reconstructed from the reference layer stream. When the current layer stream is further decoded by referring to the reference layer reconstructed images, the current layer images may be further reconstructed. When the K-th layer stream is further decoded by referring to the current layer reconstructed image, K-th layer images may be further reconstructed.

The video decoding apparatus 20 may obtain coded data of the reference layer images and the current layer images from the reference layer stream and the current layer stream, and additionally obtain a prediction vector generated by inter-prediction and prediction information generated by inter-layer prediction.

For example, the video decoding apparatus 20 may decode data inter-predicted by layers and data inter-layer predicted between multiple layers. Reconstruction through motion compensation and inter-layer decoding may be performed based on coding units or prediction units.

Images may be reconstructed by performing motion compensation for a current image by referring to reconstructed images predicted through inter-prediction of the same layer for each layer stream. The motion compensation signifies an operation of reconstructing a reconstructed image of the current image by synthesizing the current image and the reference image determined by using a motion vector of the current image.

Also, the video decoding apparatus 20 may perform inter-layer decoding by referring to the reference layer images to reconstruct the current layer image predicted through the inter-layer prediction. The inter-layer decoding signifies an operation of reconstructing a reconstructed image of the current image by synthesizing a residual of the current image and a reference image of other layer determined to predict the current image.

The video decoding apparatus 20 according to an embodiment may perform inter-layer decoding to reconstruct reference layer images predated by referring to current layer images.

However, the decoder 22 according to one or more embodiments may decode a current layer stream without referring to a reference layer image sequence. Accordingly, it is noted that the decoder 22 is not limitedly interpreted to perform only the inter-layer prediction to decode the current layer image sequence.

The video decoding apparatus 20 decodes each of images of a video by blocks. The block may be a maximum coding unit, a coding unit, a prediction unit, or a transformation unit among coding units according to a tree structure.

The decoder 22 may decode the reference layer image by using coding symbol of a parsed reference layer image. When the video decoding apparatus 20 receives streams encoded based on the coding units of a tree structure, the decoder 22 may perform decoding based on the coding units of a tree structure for each of the maximum coding unit of the reference layer stream.

The decoder 22 may obtain coded information and coded data by performing entropy encoding for each maximum coding unit. The decoder 22 may reconstruct the residual by performing inverse-quantization and inverse-transformation on coded data obtained from a stream. The decoder 22 according to another embodiment may directly receive a bitstream of quantized transform coefficients. As a result of performing inverse-quantization and inverse-transformation on the quantized transform coefficients, a residual of images may be reconstructed.

The decoder 22 may reconstruct reference layer images by combining a prediction image and the residual, through motion compensation between the same layer images.

The decoder 22 may generate the current layer prediction image by using samples of the reference layer reconstructed image, according to the inter-layer prediction structure. The decoder 22 may obtain a prediction error according to the inter-layer prediction by decoding the current layer stream. The decoder 22 may generate the current layer reconstructed image by combining the prediction error to the current layer prediction image.

The decoder 22 may determine the current layer prediction image by using the reference layer reconstructed image decoded by the decoder 22. The decoder 22 may determine a block of the reference layer image to be referred to by a block such as the coding unit or the prediction unit of the current layer image, according to the inter-layer prediction structure. For example, a reconstructed block of the reference layer image located at a position corresponding to a position of a current block in the current layer image. The decoder 22 may determine the current layer prediction block by using reference layer reconstructed block corresponding to the current layer block.

The decoder 22 may use the current layer prediction block determined by using the reference layer reconstructed block according to the inter-layer prediction structure, as the reference image for the inter-layer prediction of the current layer original block. In this case, the decoder 22 may reconstruct the current layer block by synthesizing the residual according to the inter-layer prediction and the sample value of the current layer prediction block determined by using the reference layer reconstructed image.

According to the spatial scalable video coding method, when the decoder 22 reconstructs a reference layer image having a resolution different from that of the current layer image, the decoder 22 may interpolate to allow the reference layer reconstructed image to have the same size as the current layer original image with the same resolution. An interpolated reference layer reconstructed image may be determined to be a current layer prediction image for the inter-layer prediction.

The video decoding apparatus 20 may receive data stream. The data stream received by the video decoding apparatus 20 may be configured by network abstraction layer (NAL) units.

A NAL unit may signify a network abstraction layer unit that is a basic unit forming a bitstream. Also, one or more NAL units may form a data stream. The video decoding apparatus 20 may externally receive a data stream formed of one or more NAL units.

The video decoding apparatus 20 may receive a data stream, separate the data stream by units of NAL units, and decode each separated NAL unit.

Each NAL unit may include two-byte header information. Also, the video decoding apparatus 20 may check rough information about data inside each NAL unit by decoding the two-byte header information included in each NAL unit.

The receiver 21 may receive information about whether a chroma sample is corrected.

Alternatively, the receiver 21 may receive the correction value determined by the video encoding apparatus 10. Alternatively, the receiver 22 may receive only a parameter for determining the correction value. When the receiver 21 receives only a parameter for determining the correction value, the decoder 22 may determine the correction value.

The decoder 22 may obtain a correction value determined using a luma value within a range corresponding to a position of a determined chroma pixel, based on the received information, and correct a chroma value by using an obtained correction value.

An operation of the video decoding apparatus 20 is described below with reference to FIGS. 2B to 7.

FIG. 2B is a flowchart of a method of receiving information about whether a chroma sample is corrected, obtaining a correction value, and correcting a chroma value, according to one or more embodiments.

In S211, the video decoding apparatus 20 may receive information about whether to correct a chroma sample.

For example, the video decoding apparatus 20 may determine whether a chroma sample is corrected, by parsing flag information.

The information about whether correction is performed is already described above.

In S212, the video decoding apparatus 20 may obtain the correction value determined using a luma value in a range corresponding to the position of the determined chroma pixel, based on the information received in S211.

The video decoding apparatus 20 may determine the correction value by using luma values located in a predetermined range corresponding to the position of the chroma pixel.

For example, the correction value may be a value obtained by performing a sigma operation on a value obtained by multiplying the luma values located in a predetermined range corresponding to the position of the chroma pixel by a predetermined filter coefficient.

For example, when “Ch(x,y)” is an input chroma value, “ [symbol] (x,y)” is a corrected chroma value, “(x,y)” is a value of coordinate system of a chroma value in a current layer, “Luma(ξ,ζ)” is a luma value, “(ξ,ζ)” is a coordinate system of a luma value, “{f(i,j)}” is a filter coefficient, and “M” is a multiplication coefficient, Mathematic Expression [1] below may be a correction value.

$$( M ( {\sum }_{j = {v}_{start}}^{{v}_{end }} {\sum }_{i = {h}_{start}}^{{h}_{end}} f ( i , j ) Luma ( 2 ξ + i , 2 ϛ + j ) ) ) >> Shift \qquad Mathematic Expression [ 1 ]$$

Alternatively, Mathematic Expression [2] below may be a correction value.

$$( M ( {\sum }_{j = v\_start}^{v\_end} {\sum }_{i = h\_start}^{h\_end} f ( i , j ) Luma ( 2 ξ + i , 2 ϛ + j ) ) ) \qquad Mathematic Expression [ 2 ]$$

Alternatively, Mathematic Expression [3] below may be a correction value.

$$( ( {M}_{v} ( {\sum }_{j = v\_start}^{v\_end} {f}_{v} ( j ) Luma ( 2 ξ , 2 ϛ + j ) ) + {M}_{h 0} ( {\sum }_{i = {h}_{start}}^{{h}_{end}} {f}_{h 0} ( i ) Luma ( 2 ξ + i , 2 ϛ + 0 ) ) + {M}_{h 1} ( {\sum }_{i = h\_start}^{h\_end} {f}_{h 1} ( i ) Luma ( 2 ξ + i , 2 ϛ + 1 ) ) ) >> Shift ) \qquad Mathematical Expression [ 3 ]$$

Alternatively, Mathematic Expression [4] below may be a correction value.

$$( ( {M}_{v} ( {\sum }_{j = v\_start}^{v\_end} {f}_{v} ( j ) Luma ( 2 ξ , 2 ϛ + j ) ) + {M}_{h 0} ( {\sum }_{i = {h}_{start}}^{{h}_{end}} {f}_{h 0} ( i ) Luma ( 2 ξ + i , 2 ϛ + 0 ) ) + {M}_{h 1} ( {\sum }_{i = h\_start}^{h\_end} {f}_{h 1} ( i ) Luma ( 2 ξ + i , 2 ϛ + 1 ) ) ) ) \qquad Mathematical Expression [ 4 ]$$

A filter coefficient may be normalized. For example, a value obtained by summing all filter coefficients may be 0. When a sum of all filter coefficients is 0, the video decoding apparatus 20 may determine values of all filter coefficients only if values of filter coefficients whose number is one less than the number of all filter coefficients are known.

Also, a filter coefficient may have a predetermined range. For example, a filter coefficient may have the following range.

−2̂p≦f(i·j)≦2̂(p−1)

In another example, a filter coefficient may have the following range.

−8≦f(i,j)≦7

When the minimum value of a filter coefficient is −8, the video encoding apparatus 10 may add 8 when encoding a filter coefficient value and the video decoding apparatus 20 may subtract 8 when decoding a filter coefficient value. When a method of adding/subtracting 8 is in use, a negative value may not be used during data transmission.

The video decoding apparatus 20 may determine the number of bits to present a range of each filter coefficient.

The video decoding apparatus 20 may use a multiplication coefficient when performing the above operation. The video decoding apparatus 20 may reduce the number of bits allocated to the multiplication coefficient by using information about the minimum absolute value of the multiplication coefficient.

For example, when a multiplication coefficient M has a ranged between −1024 to 1024, 11 bits are allocated to present the M. However, when the minimum absolute value of the multiplication coefficient M is 513, the multiplication coefficient M has a value between −1024 and −512 and a value between 512 and 1024 and thus 10 bits are allocated to present the multiplication coefficient M. When min_abs_M is the minimum value of M, the range of M may be expressed by the following mathematic expression.

−2̂m−min_abs_{—}M+1≦M≦−min_abs_{—}M∪min_abs_{—}M≦M≦2̂m+min_abs_{—}M−1

Accordingly, the value of min_abs_M is 1 and m is 10, −1024≦M≦0 ∪ 0≦M≦1024. Accordingly, the value of M may be expressed by 11 bits.

However, when the value of min_abs_M 513 and m is 9, −1024≦M≦−512 ∪ 512≦M≦1024.

min_abs_M and/or m may be determined in advance. The video encoding apparatus 10 may obtain min_abs_M and/or m from SPS or a first independent slice segment header.

The video encoding apparatus 10 may obtain information about the filter coefficient and the multiplication coefficient from the SPS, the VPS, the SPS, the PPS, or the slice segment header.

In S213, the video decoding apparatus 20 may correct the chroma value by using the correction value obtained in S212.

The video decoding apparatus 20 may determine the chroma value corrected by adding the correction value obtained in S212 and applying a predetermined function to the chroma value.

For example, “Ch(x,y)” is an input chroma value, “ [symbol] ” is a corrected chroma value, “(x,y)” is a value of coordinate system of a chroma value in a current layer, “Luma(ξ,ζ)” is a luma value, “(ξ,ζ)” is a coordinate system of a luma value, “{f(i,j)}” is a filter coefficient, “M” is a multiplication coefficient, “Mv” is a coefficient related to a horizontal axis, and “M_h1” and “M_h2” are coefficients related to a vertical axis, the following equation may be established.

$$( x , y ) = Clip ( Ch ( x , y ) + ( M ( {\sum }_{j = v\_start}^{v\_end} {\sum }_{i = h\_start}^{h\_end} f ( i , j ) Luma ( 2 ξ + i , 2 ϛ + j ) ) ) >> Shift ) \qquad Mathematical Equation [ 5 ]$$

Also, Mathematical Expression [6] below may be established.

$$( x , y ) = Clip ( Ch ( x , y ) + ( {M}_{v} ( {\sum }_{j = v\_start}^{v\_end} {f}_{v} ( j ) Luma ( 2 ξ , 2 ϛ + j ) ) + {M}_{h 0} ( {\sum }_{i = {h}_{start}}^{{h}_{end}} {f}_{h 0} ( i ) Luma ( 2 ξ + i , 2 ϛ + 0 ) ) + {M}_{h 1} ( {\sum }_{i = h\_start}^{h\_end} {f}_{h 1} ( i ) Luma ( 2 ξ + i , 2 ϛ + 1 ) ) ) >> Shift ) \qquad Mathematical Equation [ 6 ]$$

Accordingly, the corrected chroma value may be a value obtained by adding the correction value to an existing chroma value, performing bit shift thereon, and performing a Clip operation thereon.

Also, the corrected chroma value may be a value obtained by adding the correction value to an existing chroma value and then performing a Clip operation thereon.

When the chroma value and the luma value are obtained from a layer having the same resolution, the following equations may be established.

ξ=x,ζ=y

Also, “W_ref×H_ref” has a size of a reference layer picture and “W_cur×H_cur” has a picture size of a current layer, the following equations may be established.

ξ=x*W_ref/W_ref,ζ=y*H_ref/H_ref

However, in the equations, “Shift” is a descaling shift value that may be 16. Also in the above equations, the “Shift” may be a coded variable transmitted to SPS. Also, the “Shift” may be a coded variable transmitted to the first independent slice segment.

An example of the operation is described below.

When −8≦f(l,j)≦7, 0≦Luma(2ξ+i,2ζ+j)≦255, and Shift=16, the minimum value and the maximum value may be −24480 and 21420, respectively. When the number of filter coefficients is 12, the minimum value may be calculated to be 8*12*255. 8 may denote the minimum value of a filter coefficient, 12 may denote the number of filter coefficients, and 255 may denote the maximum value of a pixel.

$$- 8 * 12 * 255 \leq {\sum }_{j = v\_start}^{v\_end} {\sum }_{i = h\_start}^{h\_end} f ( i , j ) Luma ( 2 ξ + i , 2 ϛ + j ) \leq 7 * 12 * 255 \qquad Mathematical Inequality [ 7 ]$$

16 bits may be necessary to express a range from −24480 to 21420.

$$- 24480 \leq {\sum }_{j = v\_start}^{v\_end} {\sum }_{i = h\_start}^{h\_end} f ( i , j ) Luma ( 2 ξ + i , 2 ϛ + j ) \leq 21420 \qquad Mathematical Inequality [ 8 ]$$

Since the maximum value and the minimum value of M are 1024 and −1024, respectively, the following inequality may be obtained by multiplying −24480 and 21420 by 1024.

$$- 25067520 \leq M ( {\sum }_{j = v\_start}^{v\_end} {\sum }_{i = h\_start}^{h\_end} f ( i , j ) Luma ( 2 ξ + i , 2 ϛ + j ) ) \leq 21934080 \qquad Mathematical Inequality [ 9 ]$$

In the above inequality, the range may be expressed by 26 bits and then by 10 bits after descaling is performed.

$$( M ( {\sum }_{j = {v}_{start}}^{{v}_{end}} {\sum }_{i = {h}_{start}}^{{h}_{end}} f ( i , j ) Luma ( 2 ξ + i , 2 ϛ + j ) ) >> Shift ) \qquad Mathematical Expression [ 10 ]$$

Since the range of a chroma value is that 0≦Ch(x,y)≦255, as a clipping operation is performed, the following equation may be established.

$$( x , y ) = Clip ( Ch ( x , y ) + ( M ( {\sum }_{j = v\_start}^{v\_end} {\sum }_{i = h\_start}^{h\_end} f ( i , j ) Luma ( 2 ξ + i , 2 ϛ + j ) ) >> Shift ) ) \qquad Mathematical Equation [ 11 ]$$

Another embodiment of an operation is described below.

When the absolute value of M≦Mmax, −8≦f(l,j)≦7, 0≦Luma(2ξ+i,2ζ+j)≦255, and Shift=16,

the available maximum value and minimum value may be respectively −24480 and 21420 as described above.

Accordingly, 16 bits may be necessary to express a range from −24480 to 21420.

Also, when M is multiplied, the following inequality may be established.

$$- 24480 * {M}_{Max} \leq M ( {\sum }_{j = v\_start}^{v\_end} {\sum }_{i = h\_start}^{h\_end} f ( i , j ) Luma ( 2 ξ + i , 2 ϛ + j ) ) \leq 21420 * {M}_{Max} \qquad Mathematical Inequality [ 12 ]$$

When the Mmax value is less than 87724, a calculated value may be expressed by 32 bits.

When Shift is 16 and descaling is performed, a range of the value calculated by 16 bits may be expressed by the following mathematic expression.

$$( M ( {\sum }_{j = {v}_{start}}^{{v}_{end}} {\sum }_{i = {h}_{start}}^{{h}_{end}} f ( i , j ) Luma ( 2 ξ + i , 2 ϛ + j ) ) >> Shift ) \qquad Mathematical Expression [ 13 ]$$

Since the chroma value has a value from 0 to 255, when a clipping operation is performed, the following equation may be obtained.

$$( x , y ) = Clip ( Ch ( x , y ) + ( M ( {\sum }_{j = v\_start}^{v\_end} {\sum }_{i = h\_start}^{h\_end} f ( i , j ) Luma ( 2 ξ + i , 2 ϛ + j ) ) >> Shift ) ) \qquad Mathematical Equation [ 14 ]$$

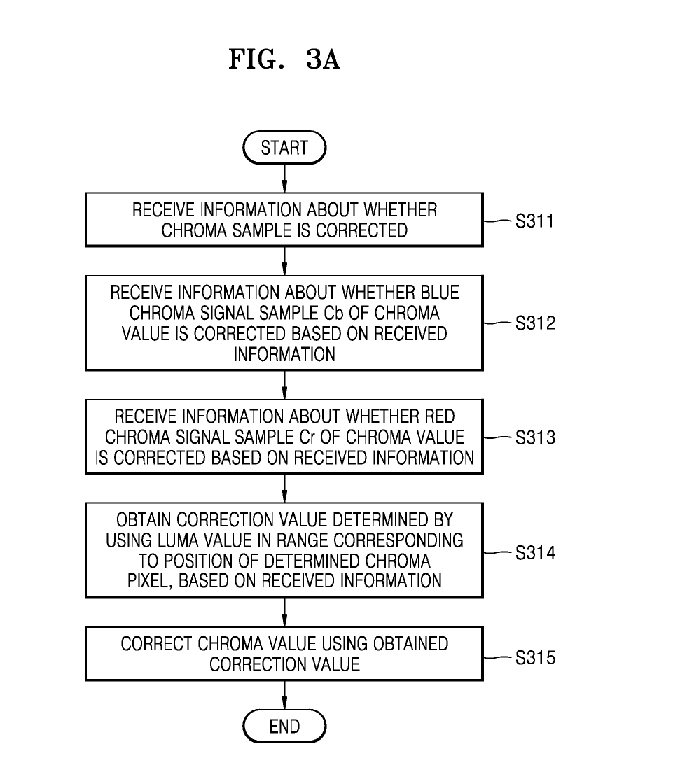

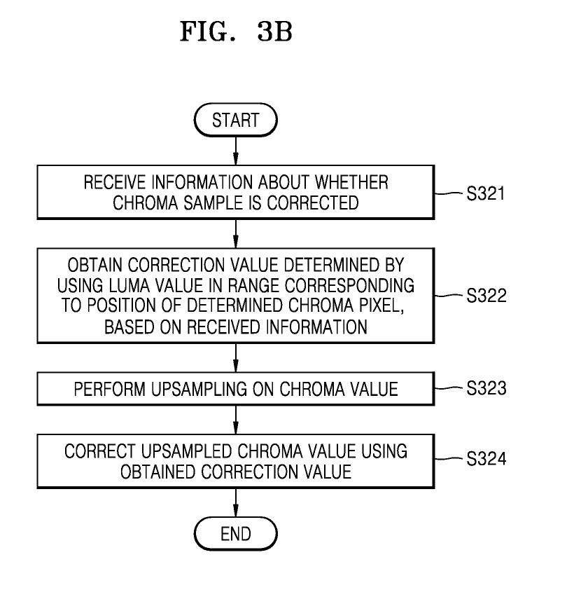

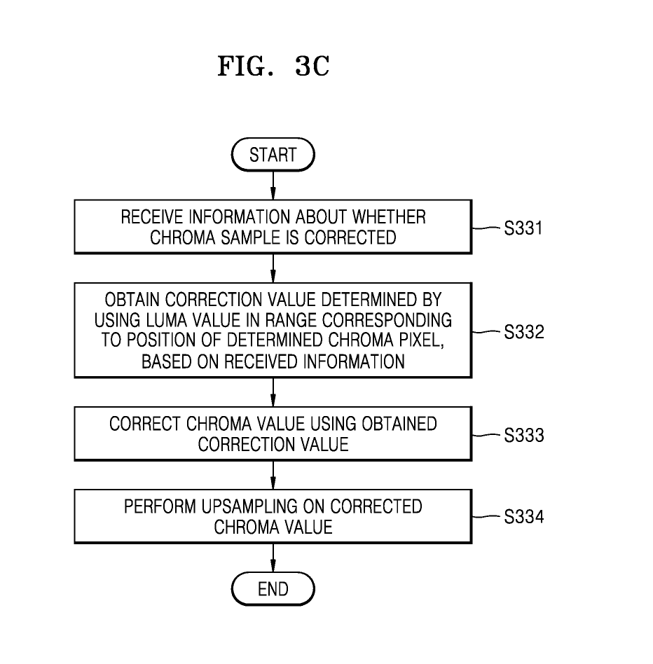

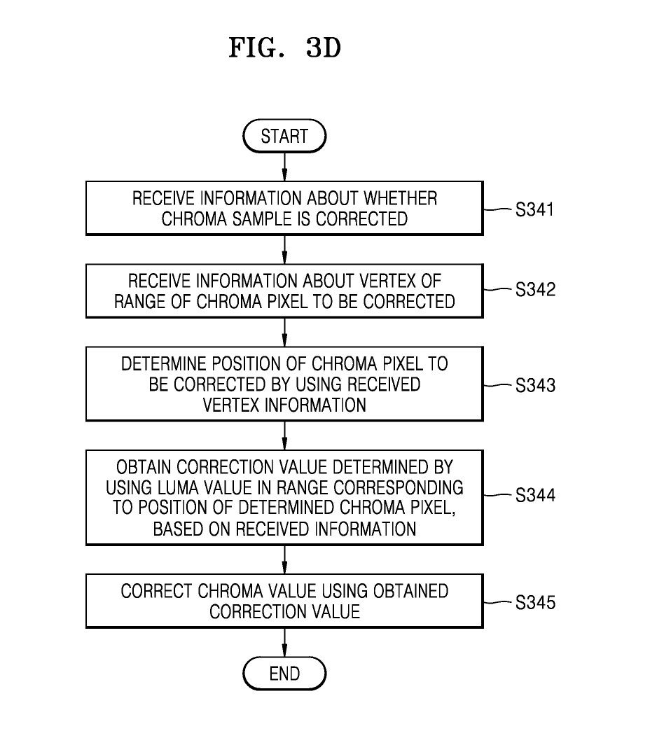

FIG. 3A is a flowchart of a method of receiving information about whether a chroma sample is corrected and then receiving information about whether a blue chroma signal Cb and a red chroma signal Cr of chroma values are corrected, according to one or more embodiments.

Since S311, S314, and S315 respectively correspond to S211, S212, and S213, detailed descriptions thereof are omitted for simplification of explanation.

In S312, the video decoding apparatus 20 may receive information about whether a blue chroma signal sample Cb of the chroma value is corrected based on the information received in S311.

The information about whether the blue chroma signal sample Cb is corrected may be in the form of a flag.

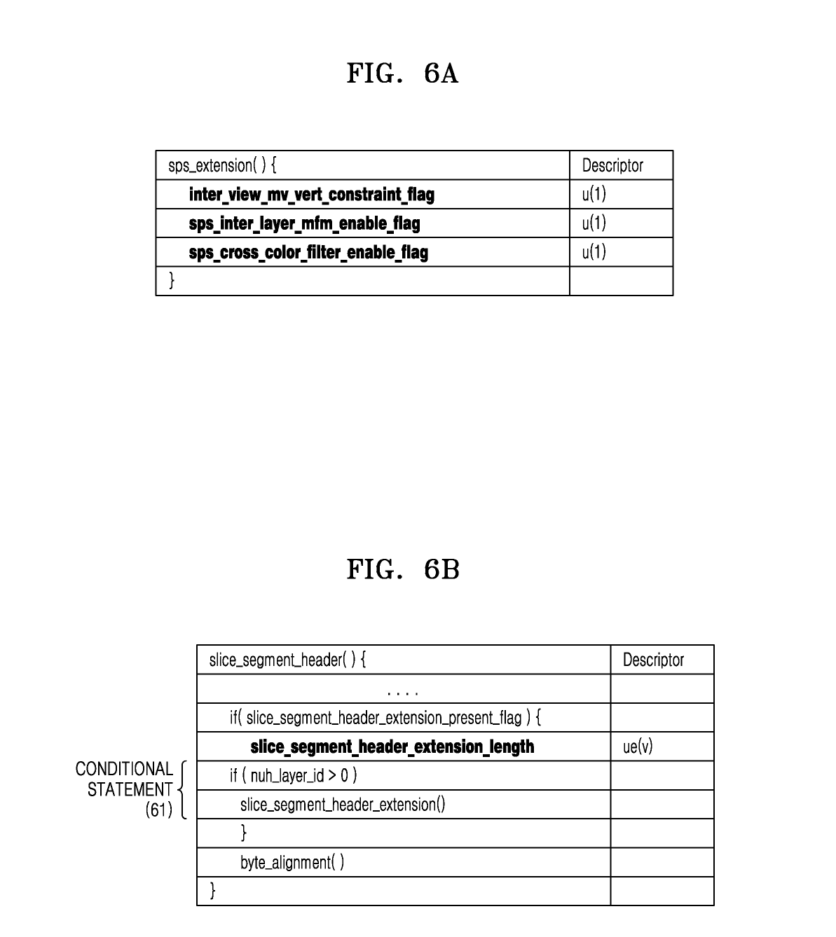

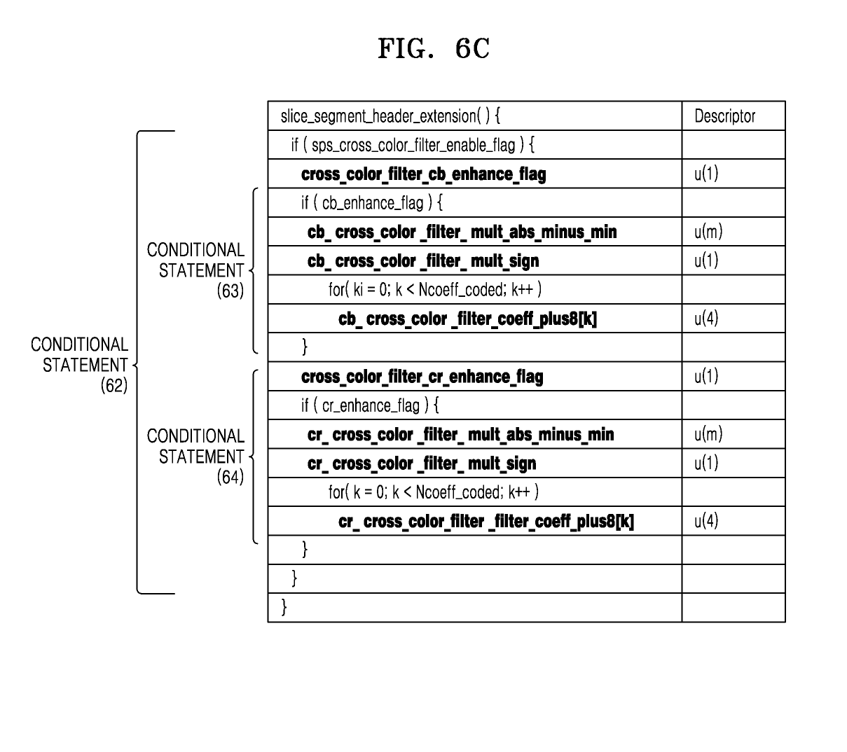

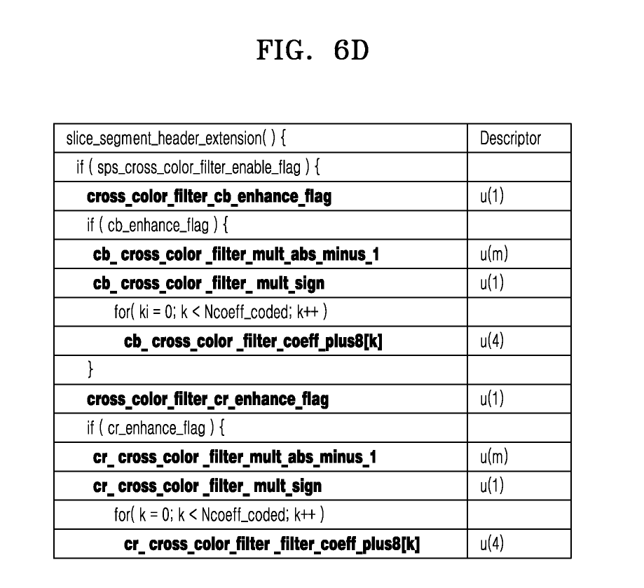

In detail, the information about whether the blue chroma signal sample Cb is corrected is described below with reference to FIG. 6C.

In S313, the video decoding apparatus 20 may receive information about whether a red chroma signal sample Cr of the chroma value is corrected based on the information received in S311.

The information about whether the red chroma signal sample Cr is corrected may be in the form of a flag.

The information about whether the blue chroma signal sample Cb is corrected is described below with reference to FIG. 6C.

FIG. 3B is a flowchart of a method of correcting a chroma value to be upsampled, according to one or more embodiments.

Since S321 and S322 respectively correspond to S211 and S212, detailed descriptions thereof are omitted for simplification of explanation.

In S323, the video decoding apparatus 20 may upsample a chroma value.

After the upsampling, a resolution of a chroma pixel may be related to a type of a YCbCr sampling format. For example, when the YCbCr sampling format is 4:2:0, the resolution may be four times by the upsampling.

In S324, the video decoding apparatus 20 may correct the chroma value upsampled in S323 by using the correction value obtained in S322.

Alternatively, the video decoding apparatus 20 may be set to correct the chroma value after the upsampling.

FIG. 3C is a flowchart of a method of performing upsampling using a chroma value to be corrected, according to one or more embodiments.

Since S331, S332, and S333 respectively correspond to S211, S212, and S213, detailed descriptions thereof are omitted for simplification of explanation.

In S334, the video decoding apparatus 20 may perform upsampling by using a corrected chroma value.

Alternatively, the video decoding apparatus 20 may be set to perform correction on a chroma value before upsampling is performed.

FIG. 3D is a flowchart of a method of receiving and using information about a vertex of a range of a chroma pixel to be corrected, according to one or more embodiments.

Since S341, S344, and S345 respectively correspond to S211, S212, and S213, detailed descriptions thereof are omitted for simplification of explanation.

In S342, the video decoding apparatus 20 may receive information about a vertex of a range of a chroma pixel to be corrected.

A vertex may signify a position of an outermost luma pixel in a range of a luma pixel used for correction of a chroma value.

For example, the video decoding apparatus 20 may receive information about a vertex corresponding to a position of a luma pixel located at the outermost position in a predetermined distance from a chroma pixel to be corrected.

Also, the vertex may signify the position of a chroma pixel to be corrected.

For example, the video decoding apparatus 20 may receive information about a vertex corresponding to the position of a chroma pixel to be corrected.

In S343, the video decoding apparatus 20 may determine the position of a chroma pixel to be corrected by using the vertex information received in S342.

For example, the video decoding apparatus 20 may determine an average coordinate value of the vertexes received in S342 as the position of a chroma pixel.

In another example, the coordinate of a vertex may be a coordinate value of a chroma pixel to be directly corrected.

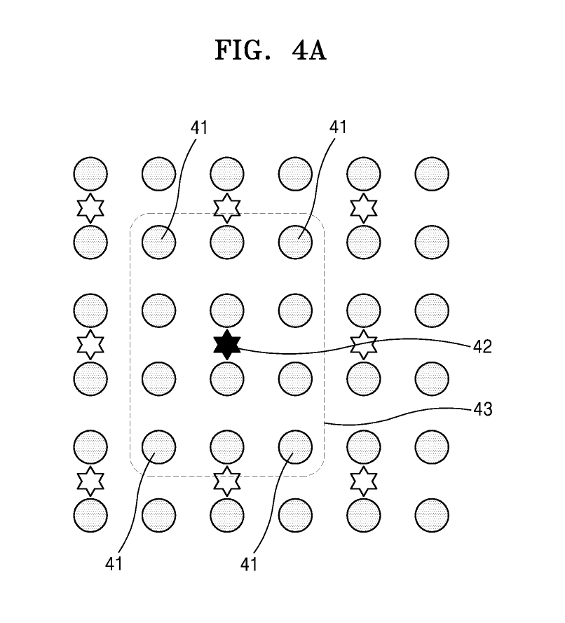

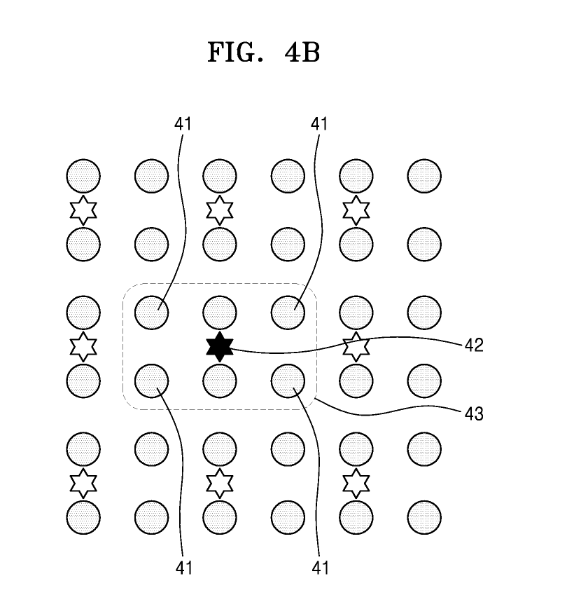

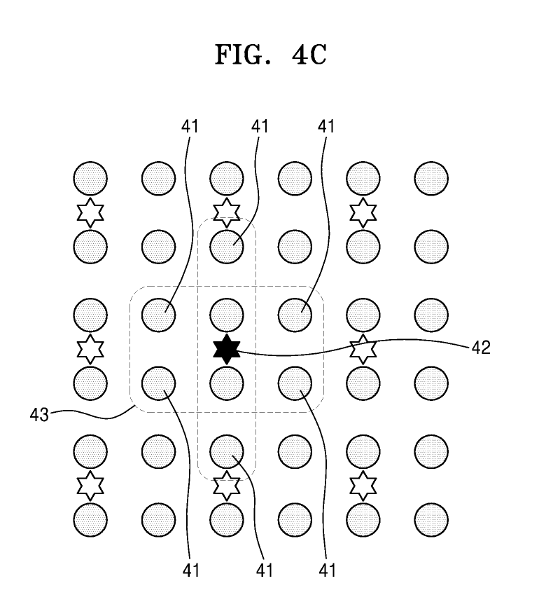

The vertex is described below with reference to FIGS. 4A to 4C.

FIG. 4A illustrates a method of correcting a chroma value according to one or more embodiments.

A chroma pixel 42 may be corrected by using luma pixels located in a predetermined range 43. Luma pixels located at the outermost side of the predetermined range 43 may be referred to as outer luma pixels 41.

In order to correct a value of the chroma pixel 42, the video decoding apparatus 20 may use values of the luma pixels located within the predetermined range 43.

The predetermined range 43 may be determined in many ways. For example, the predetermined range 43 may be previously determined. In another example, the predetermined range 43 may be a range within a predetermined distance from the chroma pixel 42 to be corrected. In another example, the predetermined range 43 may be determined according to a setting. In another example, the predetermined range 43 may be determined differently according to the values of luma pixels around the chroma pixel 42 to be corrected. In another example, the predetermined range 43 may be determined according to a value of a filter coefficient received from the video encoding apparatus 10. In another example, the predetermined range 43 may be determined based on the information received from the video encoding apparatus 10. In another example, the predetermined range 43 may be determined to be a sum of sets of two or more areas as it is seen in FIG. 4C. In another example, the predetermined range 43 may be determined to be an intersection of sets of two or more areas.

When the correction of a chroma value is performed by using the above-described Mathematical Equations [5] and [6], FIG. 4A may signify a case in which vₛₜₐᵣₜ=1, v_{end}=2, hₛₜₐᵣₜ=−1, and h_{end}=1. Accordingly, an embodiment according to FIG. 4A may signify that a 4 tap filter is performed three times.

Also, when the correction of a chroma value is performed by using the above-described Mathematical Equations [5] and [6], FIG. 4B may signify a case in which vₛₜₐᵣₜ=0, v_{end}=1, hₛₜₐᵣₜ=−1, and h_{end}=1. Accordingly, an embodiment according to FIG. 4BA may signify that a 3 tap filter is performed twice.

The positions of the outer luma pixels 41 may be the positions of vertexes.

Alternatively, the position of the chroma pixel 42 to be corrected may be the position of a vertex.

FIG. 4B illustrates a method of correcting a chroma value according to one or more embodiments.

The correspond of the chroma pixel 42 may be performed by using the luma pixels located within the predetermined range 43, as described above.

FIG. 4C illustrates a method of correcting a chroma value according to one or more embodiments.

The correction of the chroma pixel 42 may be performed by using the luma pixels located within the predetermined range 43. As it is seen in FIG. 4C, the predetermined range 43 may be determined to be a sum of sets or an intersection of sets of two or more areas.

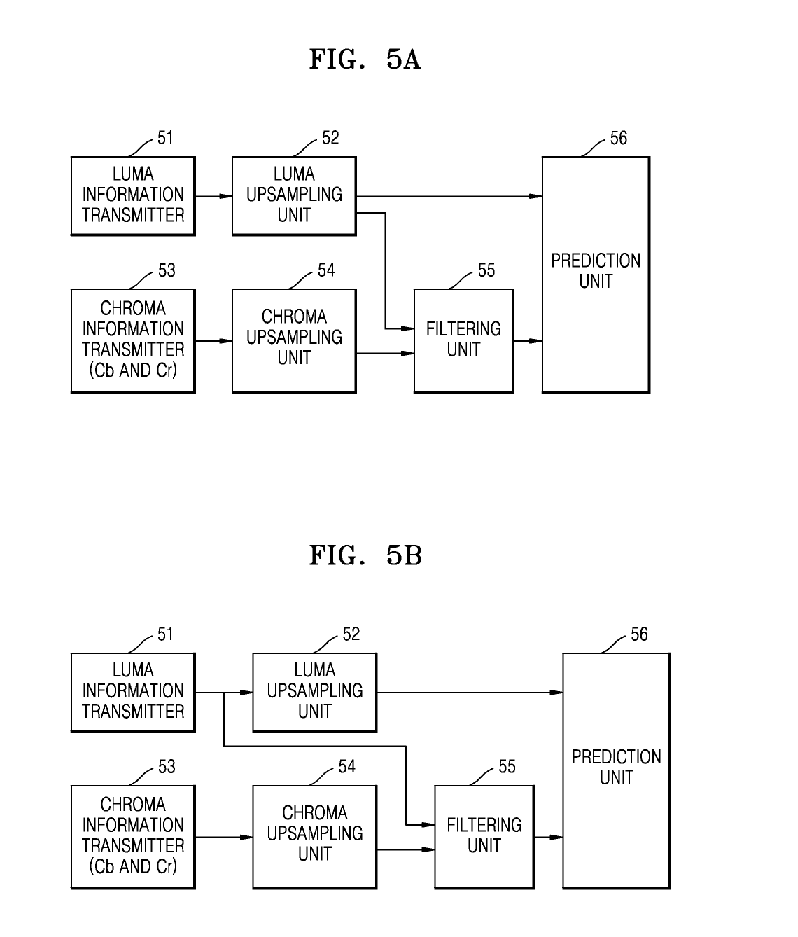

FIG. 5A is a block diagram of a method of correcting a chroma value using a luma value after upsampling is performed, according to one or more embodiments.

A luma information transmitter 51 may transmit luma information to a luma upsampling unit 52. The luma information may include information about luma values and the positions of luma pixels.

The luma upsampling unit 52 may receive chroma information from the luma information transmitter 51 and perform upsampling on the luma value. Also, the luma upsampling unit 52 may transmit a resultant value of the upsampling to a filtering unit 55 and a prediction unit 56.

A chroma information transmitter 53 may transmit the chroma information to a chroma upsampling unit 54. The chroma information may include information about chroma values and the positions of chroma pixels.

The blue chroma signal sample Cb and the red chroma signal sample Cr of the chroma value may be independently processed. For example, the chroma information transmitter 53 may transmit only the blue chroma signal sample Cb of the chroma value to the chroma upsampling unit 54.

The chroma upsampling unit 54 may receive the chroma information from the chroma information transmitter 53 and perform upsampling on the chroma value. Then, the chroma upsampling unit 54 may transmit a resultant value of the upsampling to the filtering unit 55.

The filtering unit 55 may perform filtering on the information received from the luma upsampling unit 52 and the chroma upsampling unit 54. The information received from the luma upsampling unit 52 and the chroma upsampling unit 54 may include a pixel value.

The filtering unit 55 may perform filtering on an upsampled luma value. Accordingly, the filtering unit 55 waits until the upsampling of a luma value is completed. Accordingly, a time to complete filtering in the filtering unit 55 may be delayed.

The prediction unit 56 may predict an image to be decoded, by using the information received from the luma upsampling unit 52 and the filtering unit 55. Alternatively, the prediction unit 56 may perform inter-layer prediction by using the information received from the luma upsampling unit 52 and the filtering unit 55.

FIG. 5B is a block diagram of a method of correcting a chroma value using a luma value before upsampling is performed, according to one or more embodiments.

The luma information transmitter 51 may transmit luma information to the luma upsampling unit 52 and the filtering unit 55. The luma information may include information about luma values and the positions of luma pixels.

The luma upsampling unit 52 may receive chroma information from the luma information transmitter 51 and perform upsampling on the luma value. Also, the luma upsampling unit 52 may transmit a resultant value of the upsampling to the prediction unit 56.

The chroma information transmitter 53 may transmit the chroma information to the chroma upsampling unit 54. The chroma information may include information about chroma values and the positions of chroma pixels.

The blue chroma signal sample Cb and the red chroma signal sample Cr of the chroma value may be independently processed. For example, the chroma information transmitter 53 may transmit only the blue chroma signal sample Cb of the chroma value to the chroma upsampling unit 54.

The chroma upsampling unit 54 may receive the chroma information from the chroma information transmitter 53 and perform upsampling on the chroma value. Then, the chroma upsampling unit 54 may transmit a resultant value of the upsampling to the filtering unit 55.

The filtering unit 55 may perform filtering on the information received from the luma information transmitter 51 and the chroma upsampling unit 54. The information received from the luma information transmitter 51 and the chroma upsampling unit 54 may include a pixel value.

The filtering unit 55 may perform filtering on a luma value that is not upsampled. Accordingly, the filtering unit 55 does not need to wait until the upsampling of a luma value is completed. Accordingly, the filtering unit 55 may perform filtering without a delay.

The prediction unit 56 may predict an image to be decoded, by using the information received from the luma upsampling unit 52 and the filtering unit 55. Alternatively, the prediction unit 56 may perform inter-layer prediction by using the information received from the luma upsampling unit 52 and the filtering unit 55.

FIG. 6A illustrates a method of receiving and parsing information about whether to perform filtering, according to one or more embodiments.

The video encoding apparatus 10 may transmit information about whether to perform filtering. The information about whether to perform filtering may be in the form of a flag. Also, the video encoding apparatus 10 may obtain the information about whether to perform filtering from the SPS, the VPS, the SPS, the PPS, or the slice segment header.

Also, the video decoding apparatus 20 may perform filtering by receiving the information about whether to perform filtering. The video decoding apparatus 20 may determine whether to perform filtering based on the information about whether to perform filtering.

For example, when a flag indicating whether to perform filtering is 1, the video decoding apparatus 20 may perform filtering. However, when a flag indicting whether to perform filtering is 0, the video decoding apparatus 20 may not perform filtering. When a flag indicting whether to perform filtering is 0, the video decoding apparatus 20 may exclude a filtering operation.

An example of a pseudocode related to the information about whether to perform filtering is illustrated in FIG. 6A. “sps_cross_color_filter_enable_flag” may be a flag indicating whether to perform filtering. For example, the video decoding apparatus 20 may perform filtering when “sps_cross_color_filter_enable_flag” is 1, and may not perform filtering when “sps_cross_color_filter_enable_flag” is 0. FIG. 6B illustrates a method of calling a slice segment header extension function by a slice segment header, according to one or more embodiments.

When “nuh_layer_id” is greater than 0 according to a conditional statement 61, “slice_segment_header_extension” is performed.

FIG. 6C illustrates a method of receiving and parsing information about whether to perform filtering according to a chroma type of a chroma, according to one or more embodiments.

According to a conditional statement 62, the video decoding apparatus 20 may determine whether to correct a chroma value based on received information. For example, only when “sps_cross_color_filter_enable_flag” is recognized as 1, the video decoding apparatus 20 may correct the chroma value.

According to a conditional statement 63, the video decoding apparatus 20 may determine whether to correct the blue chroma signal sample Cb based on the received information. For example, only when “cross_color_filter_cb_enable_flag” is recognized as 1, the video decoding apparatus 20 may correct the chroma value.

According to a conditional statement 64, the video decoding apparatus 20 may determine whether to correct the red chroma signal sample Cr based on the received information. For example, only when “cross_color_filter_cr_enable_flag” is recognized as 1, the video decoding apparatus 20 may correct the chroma value.

Accordingly, the video decoding apparatus 20 may separately receive pieces of information about whether to correct the chroma value, whether to correct the blue chroma signal sample Cb, and whether to correct the blue chroma signal sample Cb.

Accordingly, the video decoding apparatus 20 may separately determine information about whether to correct the chroma value, whether to correct the blue chroma signal sample Cb, and whether to correct the blue chroma signal sample Cb.

When “cross_color_filter_enable_flag” is 1, the multiplication coefficient M may not be 0. However, when “cross_color_filter_enable_flag” is not 1, the above-described multiplication coefficient M may be 0.

In the present semantics, a syntax elements may denote the following value.

f_{—}cb((k%3)−1,(k/3)−1)=cb_cross_color_filter_coeff_plus8[k]−8

f_{—}cr((k%3)−1,(k/3)−1)=cr_cross_color_filter_coeff_plus8[k]−8

“f_cb((k%3)−1,(k/3)−1)” may denote a filtering coefficient of Cb with respect to a k value.

“f_cr((k%3)−1,(k/3)−1)” may denote a filtering coefficient of Cr with respect to a k value.

When the minimum value of a filter coefficient is −8, the video encoding apparatus 10 may add 8 when encoding a filter coefficient value and the video decoding apparatus 20 may subtract 8 when decoding a filter coefficient value. When a method of adding or subtracting 8 is in use, a negative value may not be used during data transmission.

When a value of “Ncoeff_coded” is the number of coded coefficients and “Ncoeff−1” denotes “the number of coefficients−1”, if “Ncoeff_coded” and “Ncoeff−1” are the same, the following Mathematical Equation [15] and Mathematical Equation [16] may be established.

$$\begin{matrix}{f}_{Cb} ( ( Ncoeff \%3 ) - 1 , ( Ncoeff / 3 ) - 1 ) = 0 - {\sum }_{k = 0}^{Ncoeff - 1} ( cb\_cross \_color \_filter \_coeff \_plus8 [ k ] - 8 ) & Mathematical Equation [ 15 ] \\ {f}_{Cr} ( ( Ncoeff \%3 ) - 1 , ( Ncoeff / 3 ) - 1 ) = 0 - {\sum }_{k = 0}^{Ncoeff - 1} ( cr\_cross \_color \_filter \_coeff \_plus8 [ k ] - 8 ) & Mathematical Equation [ 16 ]\end{matrix}$$

In “f_cb((k%3)−1,(k/3)−1), and f_cr((k%3)−1,(k/3)−1)”, “k%3” may denote the remainder when k is divided by 3, and “k/3” may denote the quotient when k is divided by 3.

“Min_abs_M” may denote the minimum absolute value of M.

“cb_cross_color_filter_Mult_abs_minus_min” may be a syntax element for transmitting a “min_abs_M” value.

“cb_cross_color_filter_mult_sign” may be a syntax element for transferring the sign of a color multiplier M.

If a “cb_cross_color_filter_mult_sign” value is 1, then M_cb=−cb_cross_color_filter_Mult_abs_minus_min−min_abs_M.

If the “cb_cross_color_filter_mult_sign” is not 1, then M_cb=cb_cross_color_filter_Mult_abs_minus_min+min_abs_M.

If a “cr_cross_color_filter_mult_sign” value is 1, M_cr=−cr_cross_color_filter_Mult_abs_minus_min−min_abs_M.

If the “cr_cross_color_filter_mult_sign” value is not 1, M_cr=cr_cross_color_filter_Mult_abs_minus_min+min_abs_M.

FIG. 6D illustrates a method of receiving and parsing information about whether to perform filtering according to a chroma type of a chroma, according to one or more embodiments. If −1024≦M_cb≦0 ∪ 0≦M_cb≦1024 and −1024 M_cr≦0 ∪ 0≦M_crCr≦1024, then the pseudo code of FIG. 6C may be represented by a pseudo code of FIG. 6D.

Also, the video decoding apparatus 20 may obtain “sps_cross_color_filter_enable_flag”, “cross_color_filter_cb_enable_flag”, and “cross_color_filter_cr_enable_flag” from the SPS, the VPS, the SPS, the PPS, or the slice segment header.

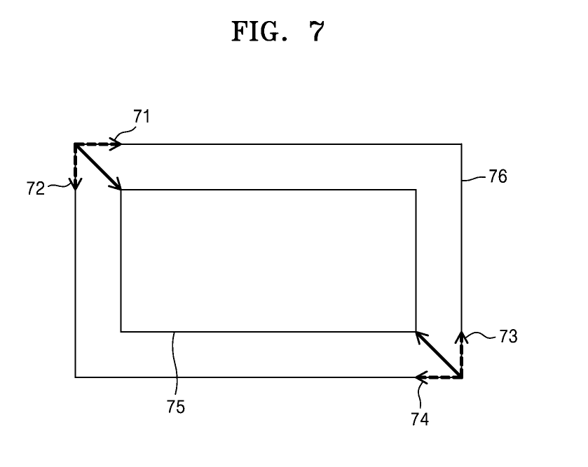

FIG. 7 illustrates a method of performing matching between a current layer and a reference layer, according to one or more embodiments.

The size of a current layer picture 76 and the size of a reference layer picture 75 may be different from each other. Accordingly, an operation process is necessary to match the current layer picture 76 and the reference layer picture 75.

In detail, the video decoding apparatus 20 may match a position of a pixel of a chroma layer to a position of a luma pixel as illustrated in FIG. 7.

When an operation to match the current layer picture 76 and the reference layer picture 75 is performed, the video decoding apparatus 20 may use a reference layer left offset 71, a reference layer upper offset 72, a reference layer lower offset 73, and a reference layer right offset 74.

The reference layer left offset 71 may denote an offset value corresponding to a horizontal distance from an upper left pixel of the current layer picture 76 to an upper left pixel of the reference layer picture 75.

The reference layer upper offset 72 may denote an offset value corresponding to a vertical distance from the upper left pixel of the current layer picture 76 to the upper left pixel of the reference layer picture 75.

The reference layer lower offset 73 may denote an offset value corresponding to a vertical distance from a lower right pixel of the current layer picture 76 to a lower right pixel of the reference layer picture 75.

The reference layer right offset 74 may denote an offset value corresponding to a horizontal distance from the lower right pixel of the current layer picture 76 to the lower right pixel of the reference layer picture 75.

The above offset values may be calculated by using the width of the current layer picture 76, the height of the current layer picture 76, the width of the reference layer picture 75, and the height of the reference layer picture 75.

Alternatively, the width of the current layer picture 76, the height of the current layer picture 76, the width of the reference layer picture 75, and the height of the reference layer picture 75 may be calculated by the above offset values.

“refW” may denote “RefLayerPicWidthInSamplesL” or a value corresponding to the width of a picture of a reference layer.

“refH” may denote “RefLayerPicHightInSamplesL” or a value corresponding to the height of a picture of a reference layer.

“scaledW” may denote “scaledRefLayerPicWidthInSamplesL” or a value corresponding to the width of a scaled reference layer picture.

“scaledH” may denote “scaledRefLayerPicHeightInSamplesL” or a value corresponding to the height of a scaled reference layer picture.

“shiftX” may be 16.

“shifty” may be 16.

“offsetX” may denote “ScaledRefLayerLeftOffset”.

“offsetY” may denote “ScaledRefLayerTopOffset”.

“scaleFactorX” and “scaleFactorY” may be obtained from the following equations.

scaleFactorX=((refW<<shiftX)+(scaledW>>1))/scaleW

scaleFactorY=((refH<<shiftY)+(scaledH>>1))/scaledH

“xRef” and “yRef” may be obtained from the following equations.

xRef=((xPoffsetX)*scaleFactorX+(1<<(shiftX−1)))>>shiftX)

yRef=((yPoffsetY)*scaleFactorY+(1<<(shiftY−1)))>>shiftY)

“RefLayerPicWidthInSamplesL” and “RefLayerPicHeightInSamplesLPicHRL” may respectively denote the width and the height of a R1 picture in a luma sample unit.

“ScaledRefLayerLeftOffset”, “ScaledRefLayerTopOffset”, “ScaledRefLayerRightOffset”, and “ScaledRefLayerBottomOffset” may be obtained from the following equations.

ScaledRefLayerLeftOffset=scaled_ref_layer_left_offset<<1

ScaledRefLayerTopOffset=scaled_ref_layer_top_offset<<1

ScaledRefLayerRightOffset=scaled_ref_layer_right_offset<<1

ScaledRefLayerBottomOffset=scaled_ref_layer_bottom_offset<<1

“ScaledRefLayerPicWidthInSamplesL” and “ScaledRefLayerPicHeightInSamplesL” may be obtained from the following equations.

ScaledRefLayerPicWidthInSamplesL=PicWidthInSamplesL−ScaledRefLayerLeftOffset−ScaledRefLayerRigthOffset

ScaledRefLayerPicHeightInSamplesL=PicHeightInSamplesL−ScaledRefLayerTopOffset−ScaledRefLayerBottomOffset

When ξ=x*W_ref/W_ref and ζ=y*H_ref/H_ref are calculated in various embodiments, a division calculation is necessary.

Various embodiments disclose a method of reducing the number of divisions. The video decoding apparatus 30 may perform the following operations when iShiftX=16, iShiftY=16, iAddX=(1<<(iShiftX−1)), iAddY=(1<<(iShiftY−1)), lScaleX=((W_ref<<iShiftX)+(W_cur>>1))/W_cur, and iScaleY=((H_ref<<iShiftY)+(H_cur>>1))/H_cur.

2ξ=((2*x*iScaleX+iAddX)>>iShiftX

2ζ=((1*y*iScaleY+iAddY)>>iShiftY

Accordingly, the same effect as when division is performed by performing a shift operation may be obtained. Although a division operation is performed in a process of operating “iScaleX” and “iScaleY”, since the “iScaleX” and the “iScaleY” are scheduled to be performed, the above operation method may reduce the number of divisions.

The above-described Equations [5] and [6] may be expressed by the following mathematical equations.

2ξ=(((2*xoffsetX)*scaleFactorX+(1<<(shiftX−1)))>>shiftX+8)>>4;

2ζ=(((2*yoffsetX)*scaleFactorY+(1<<(shiftY−1)))>>shifty+8)>>4;

Alternatively, although FIGS. 2A to 7 illustrate various embodiments of correcting a chroma value in the video decoding apparatus 20, one of ordinary skill in the art to which the present invention pertains would understand that the method described in FIGS. 2A to 7 is performed in the video encoding apparatus 10.

FIG. 8 is a block diagram of a video encoding apparatus 100 based on coding units according to a tree structure, according to one or more embodiments.

The video encoding apparatus 100 involving video prediction based on coding units according to a tree structure includes a coding unit determiner 120 and an outputter 130. Hereinafter, for convenience of description, the video encoding apparatus 100 involving video prediction based on coding units according to a tree structure according to an embodiment is referred to as “the video encoding apparatus 100”.

The coding unit determiner 120 may split a current picture based on a largest coding unit (LCU) that is a coding unit having a maximum size for a current picture of an image. If the current picture is larger than the LCU, image data of the current picture may be split into the at least one LCU. The LCU according to one or more embodiments may be a data unit having a size of 32×32, 64×64, 128×128, 256×256, etc., wherein a shape of the data unit is a square having a width and length in squares of 2.

A coding unit according to one or more embodiments may be characterized by a maximum size and a depth. The depth denotes the number of times the coding unit is spatially split from the LCU, and as the depth deepens, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU deepens, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to one or more embodiments is split according to depths, the image data of the space domain included in the LCU may be hierarchically classified according to depths.

A maximum depth and a maximum size of a coding unit, which limit the total number of times a height and a width of the LCU are hierarchically split, may be predetermined.

The coding unit determiner 120 encodes at least one split region obtained by splitting a region of the LCU according to depths, and determines a depth to output a finally encoded image data according to the at least one split region. In other words, the coding unit determiner 120 determines a final depth by encoding the image data in the deeper coding units according to depths, according to the LCU of the current picture, and selecting a depth having the least encoding error. The determined final depth and the encoded image data according to the determined depth are output to the outputter 130.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one final depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the final depths may differ according to regions in the image data. Thus, one or more final depths may be determined in one LCU, and the image data of the LCU may be divided according to coding units of at least one final depth.

Accordingly, the coding unit determiner 120 may determine coding units having a tree structure included in the LCU. The “coding units having a tree structure” according to one or more embodiments include coding units corresponding to a depth determined to be the final depth, from among all deeper coding units included in the LCU. A coding unit of a final depth may be hierarchically determined according to depths in the same region of the LCU, and may be independently determined in different regions. Similarly, a final depth in a current region may be independently determined from a final depth in another region.

A maximum depth according to one or more embodiments is an index related to the number of splitting times from a LCU to an SCU. A first maximum depth according to one or more embodiments may denote the total number of splitting times from the LCU to the SCU. A second maximum depth according to one or more embodiments may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth deepens. For convenience of description, the prediction encoding and the transformation will now be described based on a coding unit of a current depth, in a LCU.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a final depth, i.e., based on a coding unit that is no longer split to coding units corresponding to a lower depth. Hereinafter, the coding unit that is no longer split and becomes a basis unit for prediction encoding will now be referred to as a “prediction unit”. A partition obtained by splitting the prediction unit may include a prediction unit or a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residual image data in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Splitting information according to coding units corresponding to a depth requires not only information about the depth, but also about information related to prediction encoding and transformation. Accordingly, the coding unit determiner 120 not only determines a depth having a least encoding error, but also determines a partition mode in a prediction unit, a prediction mode according to prediction units, and a size of a transformation unit for transformation.

Coding units according to a tree structure in a LCU and methods of determining a prediction unit/partition, and a transformation unit, according to one or more embodiments, will be described in detail below with reference to FIGS. 7 through 19.

The coding unit determiner 120 may measure an encoding error of deeper coding units according to depths by using Rate-Distortion Optimization based on Lagrangian multipliers.

The outputter 130 outputs the image data of the LCU, which is encoded based on the at least one depth determined by the coding unit determiner 120, and information about the splitting information according to the depth, in bitstreams.

The encoded image data may be obtained by encoding the residual image data of an image.

The splitting information according to the depth may include information about the depth, about the partition mode in the prediction unit, the prediction mode, and the splitting of the transformation unit.

The information about the final depth may be defined by using splitting information according to depths, which indicates whether encoding is performed on coding units of a lower depth instead of a current depth. If the current depth of the current coding unit is the depth, image data in the current coding unit is encoded and output, and thus the splitting information may be defined not to split the current coding unit to a lower depth. Alternatively, if the current depth of the current coding unit is not the depth, the encoding is performed on the coding unit of the lower depth, and thus the splitting information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and at least one splitting information is determined for a coding unit of a depth, at least one splitting information may be determined for one LCU. Also, a depth of the image data of the LCU may be different according to locations since the image data is hierarchically split according to depths, and thus a depth and splitting information may be set for the image data.

Accordingly, the outputter 130 may assign corresponding encoding information about a depth and an encoding mode to at least one of the coding unit, the prediction unit, and a minimum unit included in the LCU.

The minimum unit according to one or more embodiments is a square data unit obtained by splitting the SCU constituting the lowermost depth by 4. Alternatively, the minimum unit according to an embodiment may be a maximum square data unit that may be included in all of the coding units, prediction units, partition units, and transformation units included in the LCU.

For example, the encoding information output by the outputter 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The outputter 130 may encode and output reference information, prediction information, and slice type information related to the prediction.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 40 described with reference to FIG. 4 may include the video encoding apparatuses 100 as many as the number of layers to encode single layer images for each layer of a multilayer video.

When the video encoding apparatus 100 encodes first layer images, the coding unit determiner 120 may determine a prediction unit for prediction between images for each coding unit according to a tree structure for each LCU and perform the prediction between images for each prediction unit.

When the video encoding apparatus 100 encodes second layer images, the coding unit determiner 120 may determine a prediction unit and a coding unit according to a tree structure for each LCU and perform inter prediction for each prediction unit.

The video encoding apparatus 100 may encode a luminance difference to compensate for a luminance difference between the first layer image and the second layer image. However, whether to perform luminance may be determined according to the coding mode of a coding unit. For example, luminance compensation may be performed only for a prediction unit having a size of 2N×2N.

FIG. 9 is a block diagram of a video decoding apparatus 200 based on coding units having a tree structure, according to one or more embodiments.

The video decoding apparatus 200 that involves video prediction based on coding units having a tree structure includes a receiver 210, an image data and encoding information extractor 220, and an image data decoder 230. For convenience of explanation, the video decoding apparatus 200 that involves video prediction based on coding units having a tree structure according to one or more embodiments is simply referred to as the video decoding apparatus 200.

Definitions of various terms, such as a coding unit, a depth, a prediction unit, a transformation unit, and information about various pieces of splitting information, for decoding operations of the video decoding apparatus 200 are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each LCU, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a final depth and splitting information for the coding units having a tree structure according to each LCU, from the parsed bitstream. The extracted final depth and splitting information are output to the image data decoder 230. In other words, the image data in a bit stream is split into the LCU so that the image data decoder 230 decodes the image data for each LCU.

The depth and splitting information according to the LCU may be set for at least one piece of depth information corresponding to the depth, and splitting information according to the depth may include information about a partition mode of a corresponding coding unit corresponding to the depth, information about a prediction mode, and splitting information of a transformation unit. Also, splitting information according to depths may be extracted as the information about a depth.

The depth and splitting information according to each LCU extracted by the image data and encoding information extractor 220 is a depth and splitting information determined to generate a minimum encoding error when an encoder, such as the video encoding apparatus 100, repeatedly performs encoding for each deeper coding unit according to depths according to each LCU. Accordingly, the video decoding apparatus 200 may reconstruct an image by decoding the image data according to a depth and an encoding mode that generates the minimum encoding error.

Since the depth and the encoding information about an encoding mode may be assigned to a predetermined data unit from among a corresponding coding unit, a prediction unit, and a minimum unit, the image data and encoding information extractor 220 may extract the depth and the splitting information according to the predetermined data units. If the depth and the splitting information of a corresponding LCU are recorded according to predetermined data units, the predetermined data units to which the same depth and splitting information are assigned may be inferred to be the data units included in the same LCU.

The image data decoder 230 reconstructs the current picture by decoding the image data in each LCU based on the splitting information and the encoding information according to the LCUs. In other words, the image data decoder 230 may decode the encoded image data based on the extracted information about the partition mode, the prediction mode, and the transformation unit for each coding unit from among the coding units having the tree structure included in each LCU. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each LCU. Via the inverse transformation, a pixel value of the space domain of the coding unit may be reconstructed.

The image data decoder 230 may determine a final depth of a current LCU by using splitting information according to depths. If the splitting information indicates that image data is no longer split in the current depth, the current depth is the depth. Accordingly, the image data decoder 230 may decode encoded data in the current LCU by using the information about the partition mode of the prediction unit, the information about the prediction mode, and the size information of the transformation unit for each coding unit corresponding to the depth.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

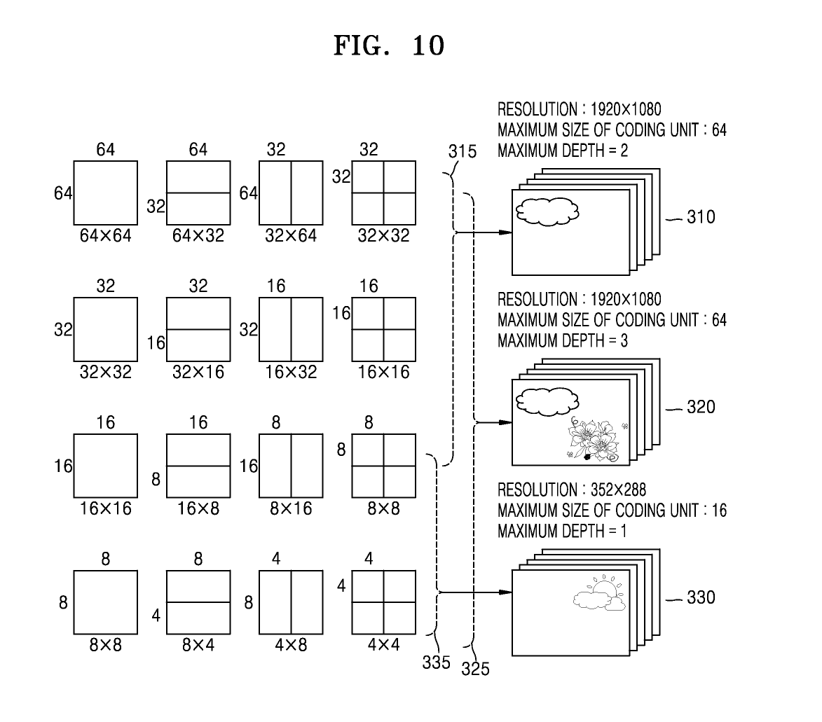

Furthermore, the video decoding apparatus 10 described with reference to FIG. 10 may include the video decoding apparatus 200 as many as the number of viewpoints to the first and second layer images by decoding received first and second layer image streams to reconstruct.

When the first layer image stream is received, the image data decoder 230 of the video decoding apparatus 200 may split samples of the first layer images extracted from the first layer image stream by coding units according to a tree structure of the LCU. The image data decoder 230 may reconstruct the first layer images by performing motion compensation for each prediction unit for prediction between images for each coding unit according to a tree structure of the samples of the first layer images.

When the second layer image stream is received, the image data decoder 230 of the video decoding apparatus 200 may split samples of the second layer images extracted from the second layer image stream by coding units according to a tree structure of the LCU. The image data decoder 230 may reconstruct the second layer images by performing motion compensation for each prediction unit for prediction between images for each coding unit according to a tree structure of the samples of the second layer images.

The extractor 220 may obtain information related to a luminance error from the bitstream to compensate for a luminance difference between the first layer image and the second layer image. However, whether to perform luminance may be determined according to the coding mode of a coding unit. For example, luminance compensation may be performed only for a prediction unit having a size of 2N×2N.

As a result, the video decoding apparatus 200 may obtain information about a coding unit that generates a minimum encoding error by performing recursively performing encoding for each LCU in an encoding process, and use the information for decoding of a current picture. In other words, decoding of coded image data of coding units according to a tree structure determined to be an optimal coding unit for each LCU may be available.

Thus, even for an image of a high resolution or an image having an excessively large data amount, the image may be reconstructed by efficiently decoding the image data according to a coding mode and the size of a coding unit adaptively determined to the characteristics of an image, by using optimal splitting information transmitted from a coding end.

FIG. 10 is a diagram for describing a concept of coding units according to one or more embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 17 denotes a total number of splits from a LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a LCU having a long axis size of 64, and coding units having long axis sizes of 32 and 16 since depths are deepened to two layers by splitting the LCU twice. Since the maximum depth of the video data 330 is 1, coding units 335 of the video data 330 may include a LCU having a long axis size of 16, and coding units having a long axis size of 8 since depths are deepened to one layer by splitting the LCU once.

Since the maximum depth of the video data 320 is 3, coding units 325 of the video data 320 may include a LCU having a long axis size of 64, and coding units having long axis sizes of 32, 16, and 8 since the depths are deepened to 3 layers by splitting the LCU three times. As a depth deepens, detailed information may be precisely expressed.

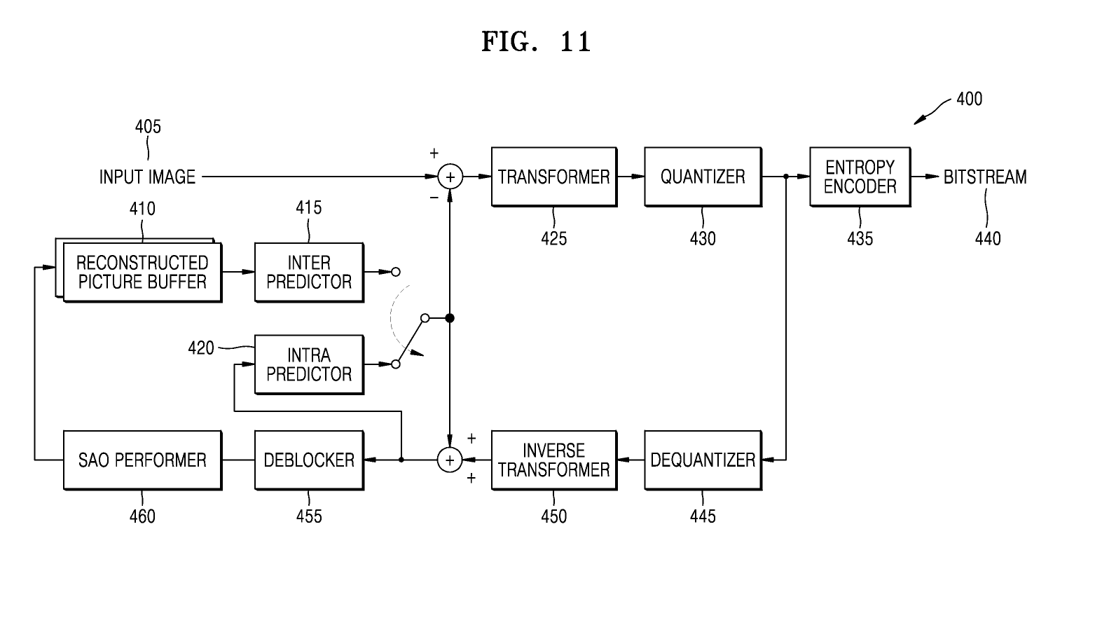

FIG. 11 is a block diagram of an image encoder 400 based on coding units, according to one or more embodiments.

The image encoder 400 performs operations necessary for encoding image data in the coding unit determiner 120 of the video encoding apparatus 100. In other words, an intra predictor 420 performs intra prediction on coding units in an intra mode according to prediction units, from among a current frame 405, and an inter predictor 415 performs inter prediction on coding units in an inter mode by using a current image 405 and a reference image obtained from a reconstructed picture buffer 410 according to prediction units. The current image 405 may be split into LCUs and then the LCUs may be sequentially encoded. In this regard, the LCUs that are to be split into coding units having a tree structure may be encoded.

Remaining image data is generated by removing prediction data regarding coding units of each mode that is output from the intra predictor 420 or the inter predictor 415 from data regarding encoded coding units of the current image 405, and is output as a quantized transformation coefficient according to transformation units through a transformer 425 and a quantizer 430. The quantized transformation coefficient is reconstructed as the residual image data in a space domain through a dequantizer 445 and an inverse transformer 450. The reconstructed residual image data in the space domain is added to prediction data for coding units of each mode that is output from the intra predictor 420 or the inter predictor and thus is reconstructed as data in a space domain for coding units of the current image 405. The reconstructed data in the space domain is generated as reconstructed images through a de-blocker 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bitstream 440 through an entropy encoder 435.

In order for the image encoder 400 to be applied in the video encoding apparatus 100, all elements of the image encoder 400, i.e., the inter predictor 415, the intra predictor 420, the transformer 425, the quantizer 430, the entropy encoder 435, the dequantizer 445, the inverse transformer 450, the de-blocker 455, and the SAO performer 460, perform operations based on each coding unit among coding units having a tree structure according to each LCU.

In particular, the intra predictor 410, the motion estimator 420, and the motion compensator 425 determines partitions and a prediction mode of each coding unit from among the coding units having a tree structure while considering the maximum size and the maximum depth of a current LCU, and the transformer 430 determines the size of the transformation unit in each coding unit from among the coding units having a tree structure.

Specifically, the intra predictor 420 and the inter predictor 415 may determine a partition mode and a prediction mode of each coding unit among the coding units having a tree structure in consideration of a maximum size and a maximum depth of a current LCU, and the transformer 425 may determine whether to split a transformation unit having a quad tree structure in each coding unit among the coding units having a tree structure.

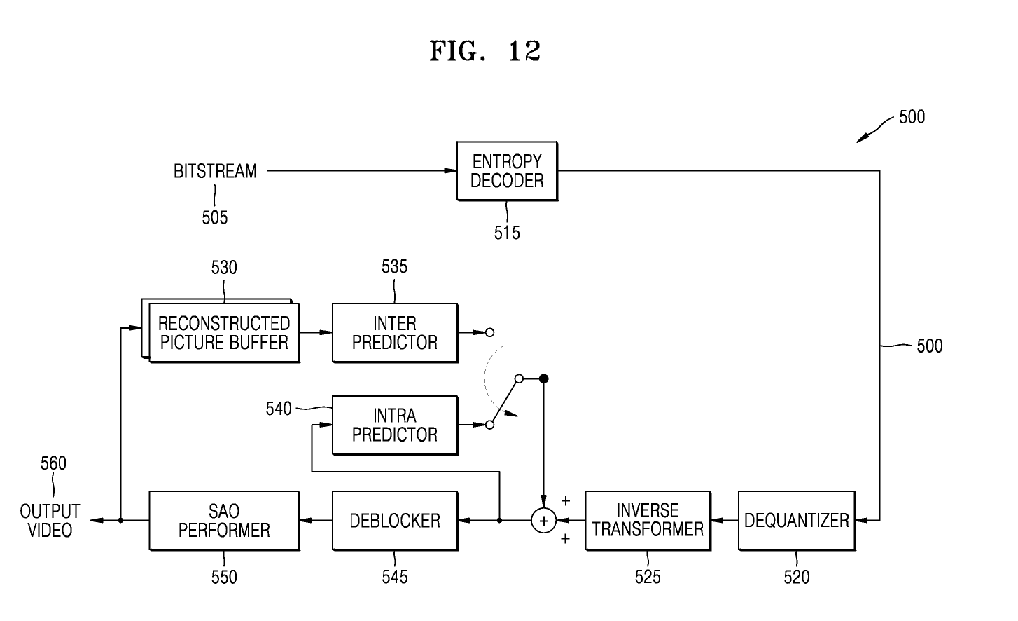

FIG. 12 is a block diagram of an image decoder 500 based on coding units, according to one or more embodiments.

An entropy decoder 515 parses encoded image data to be decoded and information about encoding required for decoding from a bitstream 505. The encoded image data is a quantized transformation coefficient from which residual image data is reconstructed by a dequantizer 520 and an inverse transformer 525.

An intra predictor 540 performs intra prediction on coding units in an intra mode according to each prediction unit. An inter predictor 535 performs inter prediction on coding units in an inter mode from among the current image 405 for each prediction unit by using a reference image obtained from a reconstructed picture buffer 530.

Prediction data and residual image data regarding coding units of each mode, which passed through the intra predictor 540 or the inter predictor 535, are summed, and thus data in a space domain regarding coding units of the current image 405 may be reconstructed, and the reconstructed data in the space domain may be output as a reconstructed image 560 through a de-blocker 545 and an SAO performer 550. Reconstructed images stored in the reconstructed picture buffer 530 may be output as reference images.

In order to decode the image data in the image data decoder 230 of the video decoding apparatus 200, operations after the entropy decoder 515 of the image decoder 500 according to an embodiment may be performed.

In order for the image decoder 500 to be applied in the video decoding apparatus 200 according to an embodiment, all elements of the image decoder 500, i.e., the entropy decoder 515, the dequantizer 520, the inverse transformer 525, the intra predictor 540, the inter predictor 535, the de-blocker 545, and the SAO performer 550 may perform operations based on each of coding units having a tree structure for each LCU.

In particular, the intra predictor 540 and the inter predictor 535 may determine a partition mode and a prediction mode for each of the coding units having a tree structure, and the inverse transformer 525 may determine whether to split a transformation unit having a quad tree structure for each of the coding units.

The encoding operation of FIG. 10 and the decoding operation of FIG. 11 are descriptions of video stream encoding and decoding operations in a single layer, respectively. Thus, when the encoder 12 of FIG. 4 encodes a video stream of two or more layers, the image encoder 400 may be included for each layer. Similarly, when the decoder 26 of FIG. 10 decodes a video stream of two or more layers, the image decoder 500 may be included for each layer.

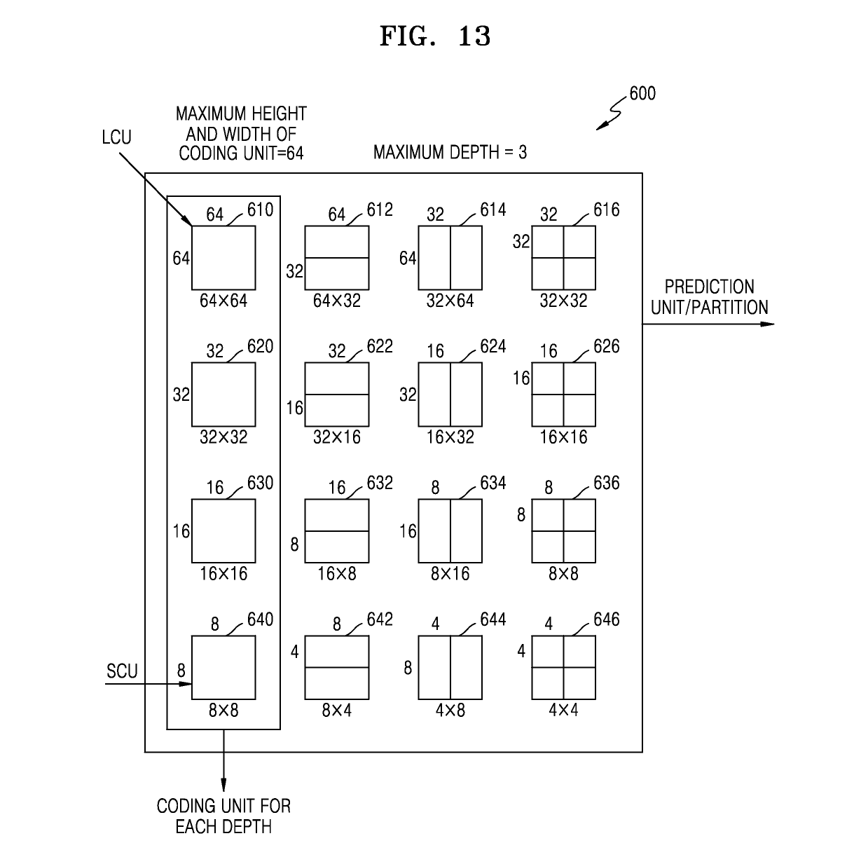

FIG. 13 is a diagram illustrating deeper coding units according to depths, and partitions, according to one or more embodiments.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to one or more embodiments, the maximum height and the maximum width of the coding units are each 64, and the maximum depth is 3. In this case, the maximum depth refers to a total number of times the coding unit is split from the LCU to the SCU. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a LCU in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is an SCU.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine a depth of the LCU 610, the coding unit determiner 120 of the video encoding apparatus 100 performs encoding for coding units corresponding to each depth included in the LCU 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the depth and a partition mode of the coding unit 610.

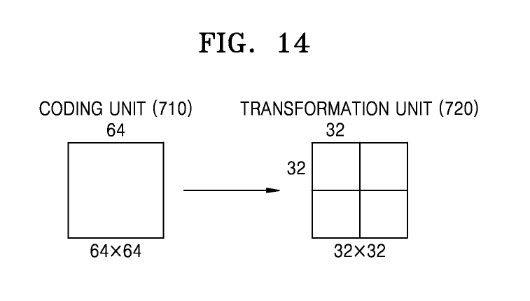

FIG. 14 is a diagram for describing a relationship between a coding unit 710 and transformation units 720, according to one or more embodiments.

The video encoding apparatus 100 or the video decoding apparatus 200 encodes or decodes an image according to coding units having sizes smaller than or equal to a LCU for each LCU. Sizes of transformation units for transformation during encoding may be selected based on data units that are not larger than a corresponding coding unit.

For example, in the video encoding apparatus 100 or the video decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

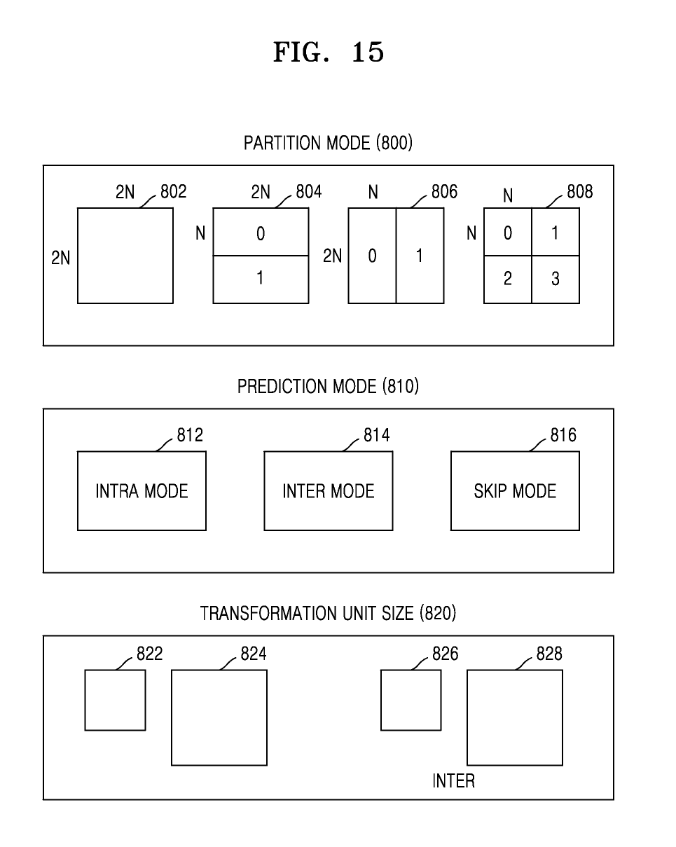

FIG. 15 is a diagram for describing encoding information of coding units corresponding to a depth, according to one or more embodiments.

The outputter 130 of the video encoding apparatus 100 may encode and transmit information 800 about a partition mode, information 810 about a prediction mode, and information 820 about a transformation unit size for each coding unit corresponding to a depth, as splitting information.

The information 800 indicates information about a mode of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition mode is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

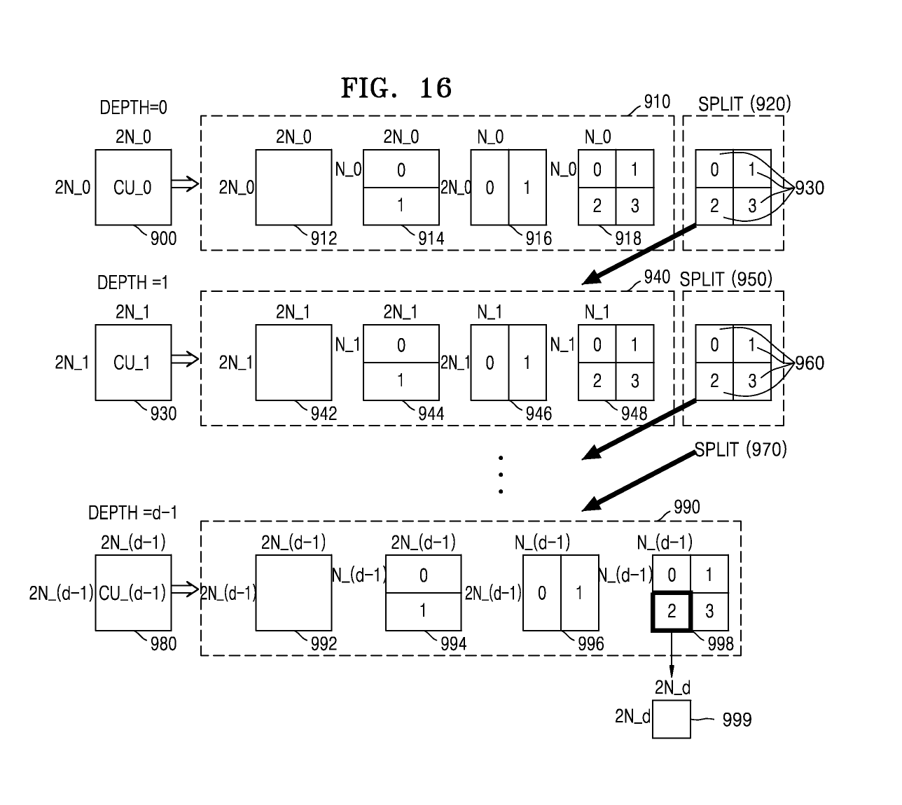

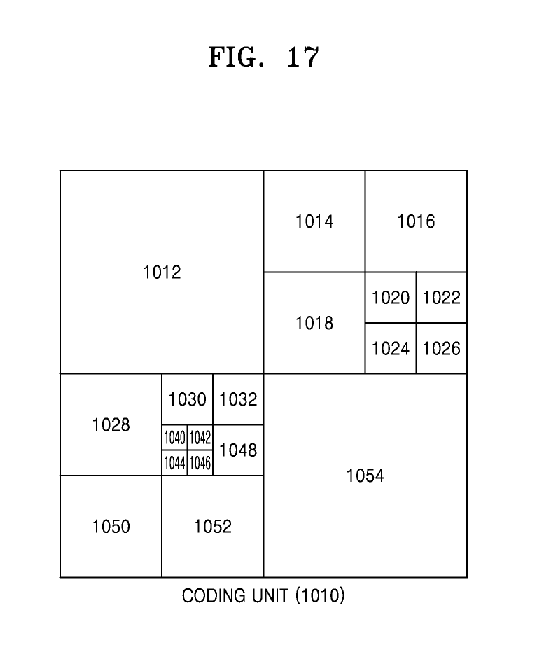

FIG. 16 is a diagram of deeper coding units according to depths, according to one or more embodiments.

Splitting information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition mode 912 having a size of 2N_{—}0×2N_{—}0, a partition mode 914 having a size of 2N_{—}0×N_{—}0, a partition mode 916 having a size of N_{—}0×2N_{—}0, and a partition mode 918 having a size of N_{—}0×N_{—}0. FIG. 23 only illustrates the partition modes 912 through 918 which are obtained by symmetrically splitting the prediction unit 910, but a partition mode is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition mode. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition modes 912 through 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition mode 942 having a size of 2N_{—}1×2N_{—}1, a partition mode 944 having a size of 2N_{—}1×N_{—}1, a partition mode 946 having a size of N_{—}1×2N_{—}1, and a partition mode 948 having a size of N_{—}1×N_{—}1.

If an encoding error is the smallest in the partition mode 948, a depth is changed from 1 to 2 to split the partition mode 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and splitting information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes 992 through 998 to search for a partition mode having a minimum encoding error.

Even when the partition mode 998 has the minimum encoding error, since a maximum depth is d, a coding unit CU_(d−1) having a depth of d−1 is no longer split to a lower depth, and a depth for the coding units constituting a current LCU 900 is determined to be d−1 and a partition mode of the current LCU 900 may be determined to be N_(d−1)×N_(d−1). Also, since the maximum depth is d and an SCU 980 having a lowermost depth of d−1 is no longer split to a lower depth, splitting information for the SCU 980 is not set.

A data unit 999 may be a “minimum unit” for the current LCU. A minimum unit according to one or more embodiments may be a square data unit obtained by splitting an SCU 980 by 4. By performing the encoding repeatedly, the video encoding apparatus 100 may select a depth having the least encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 1 through d, and a depth having the least encoding error may be determined as a depth. The depth, the partition mode of the prediction unit, and the prediction mode may be encoded and transmitted as splitting information. Also, since a coding unit is split from a depth of 0 to a depth, only splitting information of the depth is set to 0, and splitting information of depths excluding the depth is set to 1.

The image data and encoding information extractor 220 of the video decoding apparatus 200 may extract and use the information about the depth and the prediction unit of the coding unit 900 to decode the partition 912. The video decoding apparatus 200 may determine a depth, in which splitting information is 0, as a depth by using splitting information according to depths, and use the splitting information of the corresponding depth for decoding.

FIGS. 17, 18, and 19 are diagrams for describing a relationship between coding units 1010, prediction units 1060, and transformation units 1070, according to one or more embodiments.

The coding units 1010 are coding units having a tree structure, corresponding to depths determined by the video encoding apparatus 100, in a LCU. The prediction units 1060 are partitions of prediction units of each of the coding units 1010, and the transformation units 1070 are transformation units of each of the coding units 1010.

When a depth of a LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition modes in the coding units 1014, 1022, 1050, and 1054 have a size of 2N×N, partition modes in the coding units 1016, 1048, and 1052 have a size of N×2N, and a partition mode of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a LCU to determine an optimum coding unit, and thus coding units having a recursive tree structure may be obtained. Encoding information may include splitting information about a coding unit, information about a partition mode, information about a prediction mode, and information about a size of a transformation unit. Table 1 shows the encoding information that may be set by the video encoding and decoding apparatuses 100 and 200.

TABLE 1

| Splitting information 0 | | | | | Splitting |
|---|---|---|---|---|---|
| (Encoding on Coding Unit having Size of | | | | | informa- |
| 2N × 2N and Current Depth of d) | | | | | tion 1 |
| Prediction | Partition mode | | Size of | | Repeatedly |
| Mode | | | Transformation Unit | | Encode |
| Intra | Sym- | Asym- | Splitting | Splitting | Coding |
| Inter | metrical | metrical | informa- | informa- | Units |
| Skip | Partition | Partition | tion 0 of | tion 1 of | having |
| (Only | mode | mode | Trans- | Trans- | Lower Depth |
| 2N × 2N) | | | formation | formation | of d + 1 |
| | | | Unit | Unit | |
| | 2N × 2N | 2N × nU | 2N × 2N | N × N | |
| | 2N × N | 2N × nD | | (Sym- | |
| | N × 2N | nL × 2N | | metrical | |
| | N × N | nR × 2N | | Type) | |
| | | | | N/2 × N/2 | |
| | | | | (Asym- | |
| | | | | metrical | |
| | | | | Type) | |

The outputter 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a depth, and thus information about a partition mode, prediction mode, and a size of a transformation unit may be defined for the depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

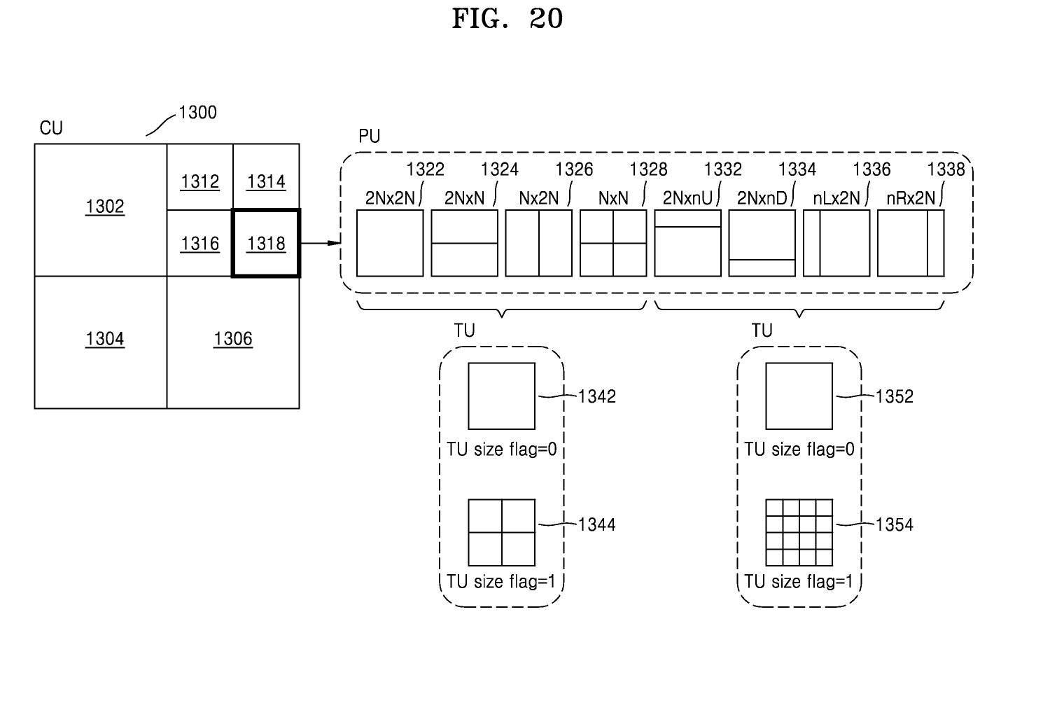

FIG. 20 is a diagram for describing a relationship between a coding unit, a prediction unit, and a transformation unit, according to encoding mode information of Table 1.

A LCU 1300 includes coding units 1302, 1304, 1306, 1312, 1314, 1316, and 1318 of depths. Here, since the coding unit 1318 is a coding unit of a depth, splitting information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Splitting information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

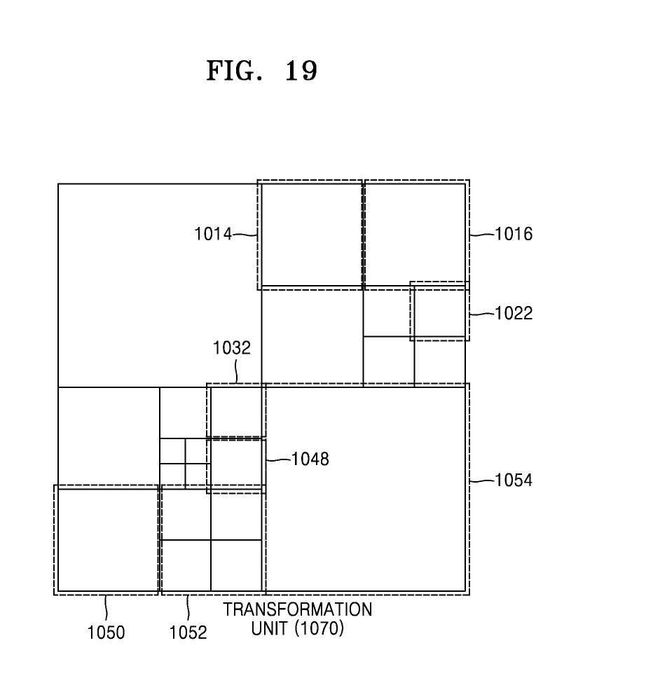

Although the TU size flag described with reference to FIG. 19 is a flag having a value or 0 or 1, but the TU size flag is not limited to 1 bit, and a transformation unit may be hierarchically split having a tree structure while the TU size flag increases from 0. Splitting information (TU size flag) of a transformation unit may be an example of a transformation index.

In this case, the size of a transformation unit that has been actually used may be expressed by using a TU size flag of a transformation unit, according to one or more embodiments, together with a maximum size and minimum size of the transformation unit. The video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is “MaxTransformSizeIndex”, a minimum transformation unit size is “MinTransformSize”, and a transformation unit size is “RootTuSize” when the TU size flag is 0, then a current minimum transformation unit size “CurrMinTuSize” that can be determined in a current coding unit, may be defined by Equation (1):

CurrMinTuSize=max(MinTransformSize,RootTuSize/(2̂MaxTransformSizeIndex)) (1)

Compared to the current minimum transformation unit size “CurrMinTuSize” that can be determined in the current coding unit, a transformation unit size “RootTuSize” when the TU size flag is 0 may denote a maximum transformation unit size that can be selected in the system. In Equation (1), “RootTuSize/(2̂MaxTransformSizeIndex)” denotes a transformation unit size when the transformation unit size “RootTuSize”, when the TU size flag is 0, is split a number of times corresponding to the maximum TU size flag, and “MinTransformSize” denotes a minimum transformation size. Thus, a smaller value from among “RootTuSize/(2̂MaxTransformSizeIndex)” and “MinTransformSize” may be the current minimum transformation unit size “CurrMinTuSize” that can be determined in the current coding unit.

According to one or more embodiments, the maximum transformation unit size RootTuSize may vary according to the type of a prediction mode.

For example, if a current prediction mode is an inter mode, then “RootTuSize” may be determined by using Equation (2) below. In Equation (2), “MaxTransformSize” denotes a maximum transformation unit size, and “PUSize” denotes a current prediction unit size.

RootTuSize=min(MaxTransformSize,PUSize) (2)

That is, if the current prediction mode is the inter mode, the transformation unit size “RootTuSize”, when the TU size flag is 0, may be a smaller value from among the maximum transformation unit size and the current prediction unit size.

If a prediction mode of a current partition unit is an intra mode, “RootTuSize” may be determined by using Equation (3) below. In Equation (3), “PartitionSize” denotes the size of the current partition unit.

RootTuSize=min(MaxTransformSize,PartitionSize) (3)

That is, if the current prediction mode is the intra mode, the transformation unit size “RootTuSize” when the TU size flag is 0 may be a smaller value from among the maximum transformation unit size and the size of the current partition unit.

However, the current maximum transformation unit size “RootTuSize” that varies according to the type of a prediction mode in a partition unit is just an example and the embodiments are not limited thereto.

According to the video encoding method based on coding units having a tree structure as described with reference to FIGS. 8 through 20, image data of the space domain is encoded for each coding unit of a tree structure. According to the video decoding method based on coding units having a tree structure, decoding is performed for each LCU to reconstruct image data of the space domain. Thus, a picture and a video that is a picture sequence may be reconstructed. The reconstructed video may be reproduced by a reproducing apparatus, stored in a storage medium, or transmitted through a network.

The present invention can also be embodied as computer readable codes on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributive manner.

For convenience of description, the above-described video encoding method and/or video encoding method will be referred to as a “video encoding method according to the one or more embodiments”. In addition, the above-described video decoding method and/or video decoding method will be referred to as a “video decoding method according to the one or more embodiments”.

Also, the above-described video encoding apparatus 40, the video encoding apparatus 100, or the video encoding apparatus including the image encoder 400 will be referred to as a “video encoding apparatus according to the one or more embodiments”. In addition, the above-described video decoding apparatus 10, the video decoding apparatus 200, or the video decoding apparatus including the image decoder 500 will be referred to as a “video decoding apparatus according to the one or more embodiments”.

A computer-readable recording medium storing a program, e.g., a disc 26000, according to one or more embodiments will now be described in detail.

FIG. 21 is a diagram of a physical structure of the disc 26000 in which a program is stored, according to one or more embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantization parameter determination method, the video encoding method, and the video decoding method described above may be assigned and stored.

A computer system embodied using a storage medium that stores a program for executing the video encoding method and the video decoding method as described above will now be described with reference to FIG. 29.

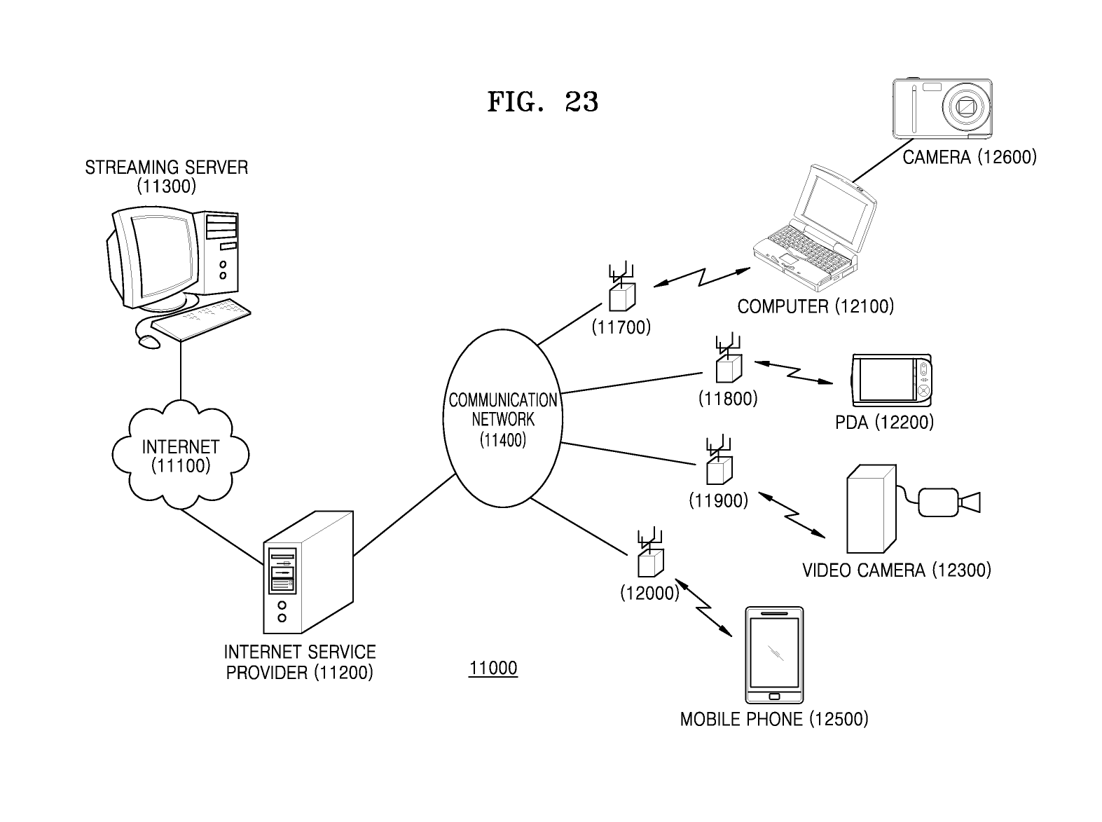

FIG. 22 is a diagram of a disc drive 26800 for recording and reading a program by using the disc 26000. A computer system 26700 may store a program that executes at least one of a video encoding method and a video decoding method according to one or more embodiments, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of a video encoding method and a video decoding method according to one or more embodiments may be stored not only in the disc 26000 illustrated in FIG. 21 or 22 but also in a memory card, a ROM cassette, or a solid state drive (SSD).

A system to which the video encoding method and a video decoding method described above are applied will be described below.

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 31, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to one or more embodiments.

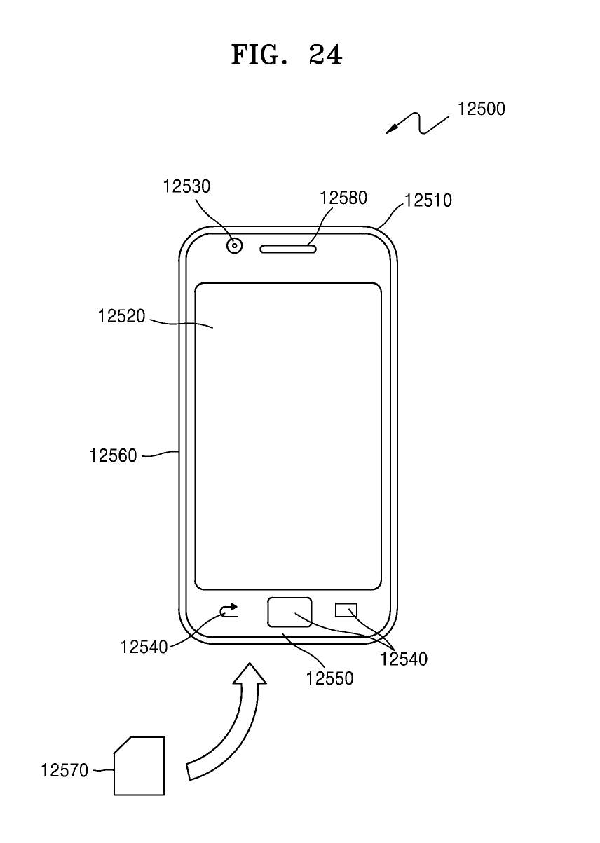

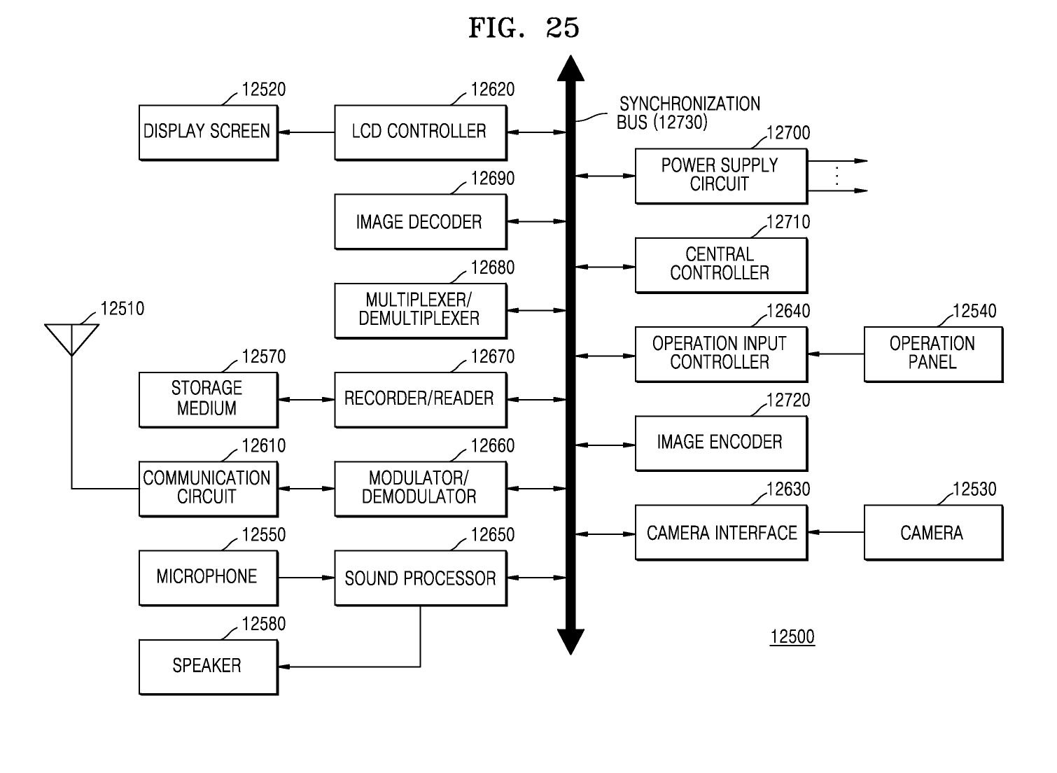

The mobile phone 12500 included in the content supply system 11000 according to one or more embodiments will now be described in greater detail with referring to FIGS. 24 and 25.

FIG. 24 illustrates an external structure of the mobile phone 12500 to which a video encoding method and a video decoding method are applied, according to one or more embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound outputter, and a microphone 12550 for inputting voice and sound or another type sound inputter. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500, according to one or more embodiments. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a “power off” state to a “power on” state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described video encoding method according to the one or more embodiments. The image encoder 12720 may transform the image data received from the camera 12530 into compressed and encoded image data based on the above-described video encoding method according to the one or more embodiments, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the above-described video decoding method according to the one or more embodiments. The image decoder 12690 may decode the encoded video data to obtain reconstructed video data and provide the reconstructed video data to the display screen 12520 via the LCD controller 12620, by using the above-described video decoding method according to the one or more embodiments.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to one or more embodiments, may be a transceiving terminal including only the video encoding apparatus, or may be a transceiving terminal including only the video decoding apparatus.

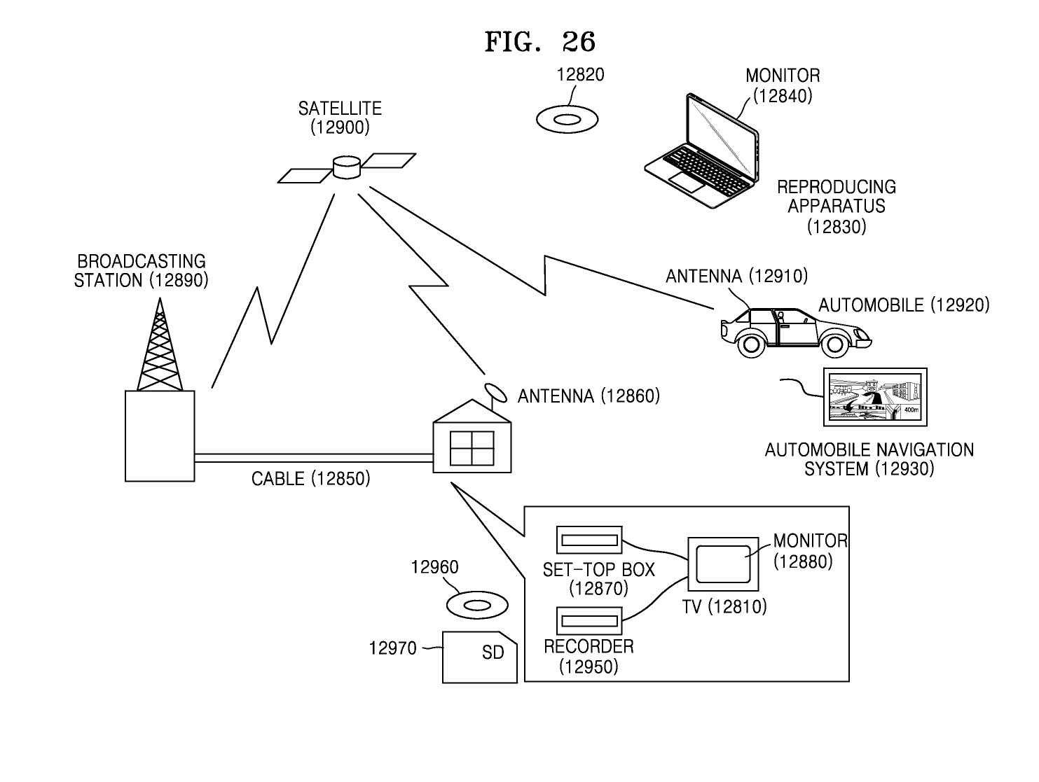

A communication system according to the one or more embodiments is not limited to the communication system described above with reference to FIG. 24. For example, FIG. 26 illustrates a digital broadcasting system employing a communication system, according to one or more embodiments. The digital broadcasting system of FIG. 26 may receive a digital broadcast transmitted via a satellite or a terrestrial network by using a video encoding apparatus and a video decoding apparatus according to one or more embodiments.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to one or more embodiments is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to one or more embodiments may be installed. Data output from the set-top box 12870 may also be reproduced on a TV monitor 12880.

As another example, a video decoding apparatus according to one or more embodiments may be installed in the TV receiver 12810 instead of the set-top box 12870.

An automobile 12920 that has an appropriate antenna 12910 may receive a signal transmitted from the satellite 12800 or the wireless base station 11700 of FIG. 21. A decoded video may be reproduced on a display screen of an automobile navigation system 12930 installed in the automobile 12920.

A video signal may be encoded by a video encoding apparatus according to one or more embodiments and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to one or more embodiments, a video signal recorded on the DVD disc 12960, the SD card 12970, or another storage medium may be reproduced on the TV monitor 12880.

The automobile navigation system 12930 may not include the camera 12530 of FIG. 32, and the camera interface 12630 and the image encoder 12720 of FIG. 32. For example, the computer 12100 and the TV receiver 12810 may not include the camera 12530, the camera interface 12630, and the image encoder 12720.

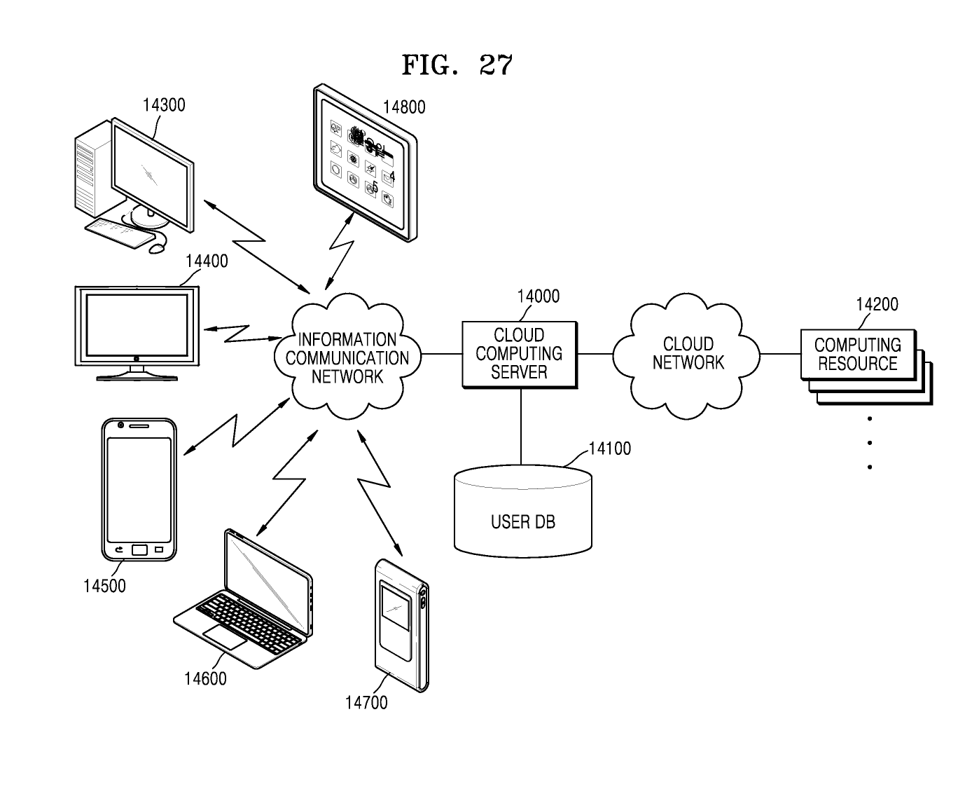

FIG. 27 is a diagram illustrating a network structure of a cloud computing system using a video encoding apparatus and a video decoding apparatus, according to one or more embodiments.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include the above-described video decoding apparatus. As another example, the user terminal may include the above-described video encoding apparatus. Alternatively, the user terminal may include both the video decoding apparatus and the video encoding apparatus as described above.

Various applications of the video encoding method, the video decoding method, the video encoding apparatus, and the video decoding apparatus according to the one or more embodiments have been described above with reference to FIGS. 21 to 27. However, the methods of storing the video encoding method and the video decoding method in a storage medium or the methods of implementing the video encoding apparatus and the video decoding apparatus in a device, according to various embodiments, are not limited to the embodiments described above with reference to FIGS. 21 to 27.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

1. A video decoding method comprising:
receiving information about whether to correct a chroma sample;
obtaining a correction value determined using a luma value in a range corresponding to a position of a determined chroma pixel, based on the received information; and
correcting a chroma value using the obtained correction value.

2. The video decoding method of claim 1, wherein the receiving of the information about whether to correct comprises:
receiving information about whether a blue chroma signal sample Cb of the chroma value is corrected based on the received information; and
receiving information about whether a red chroma signal sample Cr of the chroma value is corrected based on the received information.

3. The video decoding method of claim 1, wherein the correcting comprises:
upsampling the chroma value; and
correcting the upsampled chroma value.

4. The video decoding method of claim 1, further comprising performing upsampling using the corrected chroma value.

5. The video decoding method of claim 1, wherein the obtaining of the determined correction value comprises:
receiving vertex information of a range of a chroma pixel to be corrected; and
determining a position of the chroma pixel to be corrected using the received vertex information.

6. A video encoding method comprising:
determining a correction value using a luma value in a range corresponding to a position of a chroma pixel;
correcting a chroma value using the determined correction value; and
transmitting information about whether to correct the chroma value.

7. The video encoding method of claim 6, wherein the transmitting of the information about whether to correct comprises:
transmitting information about whether a blue chroma signal sample Cb of the chroma value is corrected based on the transmitted information; and
transmitting information about whether a red chroma signal sample Cr of the chroma value is corrected based on the transmitted information.

8. The video encoding method of claim 6, wherein the correcting comprises:
upsampling the chroma value; and
correcting the upsampled chroma value.

9. The video encoding method of claim 6, further comprising performing upsampling using the corrected chroma value.

10. The video encoding method of claim 6, wherein the determining of the correction value comprises:
determining a vertex of a range of a chroma pixel to be corrected; and
transmitting information about the determined vertex.

11. A video decoding apparatus comprising:
a receiver receiving information about whether to correct a chroma sample; and
a decoder obtaining a correction value determined using a luma value in a range corresponding to a position of a determined chroma pixel, based on the received information, and correcting a chroma value using the obtained correction value.

12. A video encoding apparatus comprising:
an encoder determining a correction value using a luma value in a range corresponding to a position of a chroma pixel, and correcting a chroma value using the determined correction value; and
a transmitter transmitting information about whether to correct the chroma value.

13. A non-transitory computer readable storage medium having stored thereon a program, which when executed by a computer, performs the method defined in claim 1.

14. A non-transitory computer readable storage medium having stored thereon a program, which when executed by a computer, performs the method defined in claim 6.
